(19) United States
(12) Patent Application Publication
(10) Pub. No.: US 2011/0280314 A1
(43) Pub. Date: Nov. 17, 2011

(54) SLICE ENCODING AND DECODING PROCESSORS, CIRCUITS, DEVICES, SYSTEMS AND PROCESSES

(75) Inventors: Jagadeesh Sankaran, Allen, TX (US); Sajish Sajayan, Bangalore (IN); Sanmati S. Kamath, Plano, TX (US)

(73) Assignee: TEXAS INSTRUMENTS INCORPORATED, Dallas, TX (US)

(21) Appl. No.: 12/815,734

(22) Filed: Jun. 15, 2010

Related U.S. Application Data
(60) Provisional application No. 61/333,891, filed on May 12, 2010.

(51) Int. Cl. H04N 7/12; G06F 13/00; G06F 3/00

(52) U.S. Cl. 375/240.25; 710/15; 710/33; 710/14; 375/E07.026

(57) ABSTRACT

A video decoder includes a memory (140) operable to hold entropy coded video data accessible as a bit stream, a processor (100) operable to issue at least one command for loose-coupled support and to issue at least one instruction for tightly-coupled support, a bit stream unit (110.1) coupled to said memory (140) and to said processor (100) and responsive to at least one command to provide the loose-coupled support and command-related accelerated processing of the bit stream, and a second bit stream unit (110.2) coupled to said memory (140) and to said processor (100) and responsive to said at least one instruction to provide the tightly-coupled support and instruction-related accelerated processing of the bit stream. Other encoding and decoding processors, circuits, devices, systems and processes are also disclosed.

### CROSS-REFERENCES TO RELATED APPLICATIONS

This application is related to provisional U.S. patent application “Slice Encoding and Decoding Processors, Circuits, Devices, Systems and Processes” Ser. No. 61/333,891 (TI-67049PS), filed May 12, 2010, for which priority is claimed under 35 U.S.C. 119(e) and all other applicable law, and which is incorporated herein by reference in its entirety.

This application is related to U.S. Pat. No. 7,176,815 “Video coding with CABAC” (TI-39208), dated Feb. 13, 2007, which is incorporated herein by reference in its entirety.

This application is related to U.S. patent application Publication “Video error detection, recovery, and concealment” 20060013318, dated Jan. 19, 2006 (TI-38649), which is incorporated herein by reference in its entirety.

This application is related to U.S. patent application Publication “Video Coding” 20080317134, dated Dec. 25, 2008 (TI-36672), which is incorporated herein by reference in its entirety.

This application is related to U.S. patent application “Fast Residual Encoder in Video Codec” Ser. No. 12/776,496 (TI-66442), filed May 10, 2010, which is incorporated herein by reference in its entirety.

### STATEMENT REGARDING FEDERALLY SPONSORED RESEARCH OR DEVELOPMENT

Not applicable.

### COPYRIGHT NOTIFICATION

Portions of this patent application contain materials that are subject to copyright protection. The copyright owner has no objection to the facsimile reproduction by anyone of the patent document, or the patent disclosure, as it appears in the United States Patent and Trademark Office, but otherwise reserves all copyright rights whatsoever.

### BACKGROUND

Fields of technology include telecommunications, digital signal processing and compression and decompression of image data and other forms of compressed data communicated and transferred as one or more bit streams in serial or parallel form.

Imaging and video in consumer electronics such as digital video cameras, digital camcorders and video cellular phones and other video devices, and any applicable mobile, portable and fixed devices, call for an efficient architecture to handle such data. Modules for video and image processing, for instance, should be functionally flexible and efficient in silicon area, speed, and power management.

Structures and processes are desired for efficiently and rapidly handling various functions in encoding and decoding under advanced video codec standards such as H.264, various other H.xxx and MPEG x standards and AVS, among others. (AVS is a Chinese video codec standard.) Digital video signal processing, and devices and methods for video encoding and/or decoding need to be enhanced.

H.264/AVC (Advanced Video Coding) is a recent video coding standard that makes use of several advanced video coding tools to provide better compression performance than existing video coding standards such as MPEG-2, MPEG-4, and H.263. At the core of all of these standards is the hybrid video coding technique of block motion compensation plus transform coding. Generally, block motion compensation is used to remove temporal redundancy between successive images (frames), whereas transform coding is used to remove spatial redundancy within each frame. FIGS. 11A and 11B illustrate the H.264/AVC functional blocks which include quantization of transforms of block prediction errors (either from block motion compensation or from intra-frame prediction) and entropy coding of the quantized items.

### SUMMARY OF THE INVENTION

Generally, and in one form of the invention, a video decoder includes a memory operable to hold entropy coded video data accessible as a bit stream, a processor operable to issue at least one command for loose-coupled support and to issue at least one instruction for tightly-coupled support, a bit stream unit coupled to the memory and to the processor and responsive to at least one command to provide the loose-coupled support and command-related accelerated processing of the bit stream, and a second bit stream unit coupled to the memory and to the processor and responsive to the at least one instruction to provide the tightly-coupled support and instruction-related accelerated processing of the bit stream.

Generally, and in another form of the invention, a bit stream decoder includes a processor operable to issue at least one command for loose-coupled support, and to issue at least one instruction for tightly-coupled support, and having processor delay slots; and bit stream hardware responsive to such command and operable as a substantially autonomous unit independent of the processor delay slots to provide accelerated processing of the bit stream.

Generally, and in a further form of the invention, a data processing circuit includes a processor operable to issue at least one command for loose-coupled support, and to issue at least one instruction for support during processor delay slots, and an accelerator responsive to execute at least one bit stream processing instruction to provide accelerated processing of the bit stream during processor delay slots, such instruction selected from any of get bits, put bits, show bits, entropy decode, and byte align bit pointer.

Generally, and in an additional form of the invention, an electronic circuit includes a bus, an input register coupled for entry of data from the bus, a data working buffer coupled to the input register, an output register coupled to the bus for read access thereof, a transfer circuit selectively operable to transfer data from the data working buffer to the output register, a data width request register coupled to the bus, and a control logic circuit conditionally operable in response to the data width request register to detect a first condition responsive at least to the data width request register when a data unit size in the data working buffer would be exceeded to activate repeated control of the transfer circuit for plural transfer operations, and otherwise operable on a second condition representing that the data unit size is not exceeded to execute a data processing operation involving the data working buffer, and after detection of either of the conditions further operable to issue a subsequent control for a further transfer circuit operation.

Generally, and in another further form of the invention, a bit processing circuit includes an instruction register operable to hold a request value electronically representing a number of bits to extract from data, a first data register having a width, a second data register having a second width and coupled to the first data register, a source of data coupled to at least the second data register, an output register, a remaining bits register operable to hold a remaining-number value electronically representing a number for data bits remaining in the second data register, and a control circuit responsive to the instruction register to copy bits from the first data register to the output register equal in number to the request value, transfer the rest of the bits in the first data register toward one end of the first data register regardless of the copied bits, transfer bits from the second data register to the first data register equal in number to the request value, and decrement the remaining-number value by the request value.

Generally, and in still another form of the invention, an emulation prevention data processing circuit includes a bit stream circuit for a bit stream to which emulation prevention applies, a bit pattern register circuit for holding a plurality of bit patterns, a plurality of comparators coupled to the register circuit and operable to respectively compare each of the bit patterns held in the register circuit with the bit stream, the comparators having match outputs, and an output register having a flag field which is coupled for activation if any of the match outputs from the comparators becomes active.

Generally, and in yet another form of the invention, an electronic bit insertion circuit includes a working buffer circuit of limited size operable to store bits and to specify a bit pointer position, an insertion register circuit operable to store insertion bits and a width value pertaining to the insertion bits, an output register circuit, and a control circuit operable to initially transfer at least some of the insertion bits to the working buffer circuit and transfer all the bits in the working buffer circuit to the output circuit and conditionally operable, when a sum of the bit pointer position and the width value exceeds the limited size, to transfer the remaining bits among the insertion bits to the working buffer circuit and additionally transfer the remaining insertion bits to the output circuit.

Generally, and in yet another form of the invention, an electronic bits transfer circuit includes a data working buffer operable to receive a data stream segment including one or more bytes, an output register circuit, and a control circuit including a shift circuit and operable to assemble a contiguous set of bits spanning one or more of the bytes by oppositely-directed shifts of bits involving at least one of the data working buffer and the output register, so that bits extraneous to requested bits are eliminated.

Other decoders, encoders, codecs, circuits, devices and systems and processes for their operation and manufacture are disclosed and claimed.

### BRIEF DESCRIPTION OF THE DRAWINGS

FIG. 1 is a block diagram of an inventive system for bit stream processing and acceleration of bit stream processing.

FIG. 2 is a block diagram of an inventive system for bit stream processing and acceleration of bit stream processing such as in FIG. 1 and emphasizing tightly-coupled and loose-coupled modes and structures.

FIG. 3 is a block diagram further detailing parts of the inventive system of FIG. 2 and inventively using two stream decoder stages and a shared stream data unit.

FIG. 4 is a block diagram further detailing inventive parts of the inventive system of FIGS. 1-3 with a Command register for tightly-coupled modes and structures and Instruction register for loose-coupled modes and structures.

FIG. 5 is a block diagram further detailing inventive parts of the inventive system of FIGS. 1-4 with a Request register to handle instructions for different types of entropy decode-related syntax element decodes.

FIG. 5A is a detail of an example of an inventive CodeNum generator for FIG. 5.

FIG. 6 is a block diagram further detailing an inventive Start Code detector for the inventive system of FIG. 4 responsive to the Command register for loose-coupled operation.

FIGS. 7A and 7B are two halves of a composite block diagram of inventive bit stream unit structures called TI_Get_bits hardware wherein:

FIG. 7A is a partially-block, partially-schematic diagram further detailing inventive emulation prevention byte insertion and removal structures for use in FIGS. 1-4; and

FIG. 7B is a block diagram further detailing inventive structures in FIGS. 2-4 responsive to the Instruction register for tightly-coupled operation.

FIG. 8A is a partially-block, partially flow diagram of a first inventive process of conditionally operating the inventive circuitry in FIG. 7B for bit extraction.

FIG. 8B is a partially-block, partially flow diagram of a second inventive process of conditionally operating the inventive circuitry in FIG. 7B for bit extraction.

FIG. 9 is a block diagram detailing inventive bit pattern insertion structures called TI_Put_bits hardware for use in FIGS. 1-4 and responsive to the Instruction register for tightly-coupled operation.

FIG. 9A is a block diagram of an insertion register and number of insertion bits, each accessible according to an index i.

FIG. 9B is a partially-block, partially-flow diagram of an inventive process for various bit operations in the inventive structures of FIG. 9 according to a first condition wherein a buffer Dbuffer of limited size encompasses the bit operations.

FIG. 9C is a partially-block, partially-flow diagram of an inventive process for various bit operations in the structures of FIG. 9 according to a second condition wherein the limited-size Dbuffer leaves remaining bits according to a bit operation that is followed up to complete the insertion.

FIG. 10 is a block diagram detailing inventive bit pattern interface structures called TI_Show_bits hardware for use in FIGS. 1-4 and responsive to the Instruction register for tightly-coupled operation.

FIG. 10A is a partially-block, partially-flow diagram of an inventive process for various bit operations in the structures of FIG. 10 according to a first condition wherein a temporary register Temp of limited size encompasses in size the show bit operations.

FIG. 10B is a partially-block, partially-flow diagram of an inventive process for various bit operations in the structures of FIG. 10 according to a second condition wherein the limited-size Temp register leaves remaining bits according to a bit operation that is followed up to complete the show bits operations.

FIG. 11A is a block diagram of a video encoder for use as an inventive combination with the inventive structures and processes depicted in the other Figures.

FIG. 11B is a block diagram of a video decoder for use as an inventive combination with the inventive structures and processes depicted in the other Figures.

FIG. 12 is a combined block diagram and flow diagram of an entropy decoder for use as an inventive combination with the inventive structures and processes depicted in FIG. 11B and the other Figures.

FIG. 13 is a block diagram further detailing an inventive programmable ECD (Entropy Coder and Decoder).

FIG. 14 is a block diagram of an inventive system for multimedia processing and telecommunications improved as shown in the other Figures.

Corresponding numerals in different Figures indicate corresponding parts except where the context indicates otherwise. A minor variation in capitalization or punctuation for the same thing does not necessarily indicate a different thing. A suffix .i or .j refers to any of several numerically suffixed elements having the same prefix.

### DETAILED DESCRIPTION OF EMBODIMENTS

Various embodiments herein are applicable to AVS, H.264 and any other imaging/video encode and/or decode processes or packet processing methods to which the embodiments can similarly benefit. Some embodiments herein are implemented into an image and video (IVA) H.264 video codec or an AVS (Chinese standard) high definition (HD) ECD (Entropy Coder and Decoder) core, or other packet processor, or otherwise, and provide accelerated performance. Various ones of the embodiments are useful in video apparatus, in wireless and wireline telecommunications apparatus, in set top boxes for television and other video apparatus, and for application specific processing integrated circuits, systems on a chip, and other components and systems.

Some embodiment systems (e.g., cellphones, PDAs, digital cameras, notebook computers, etc.) perform preferred embodiment methods with any of several types of hardware, such as digital signal processors (DSPs), general purpose programmable processors, application specific circuits, or systems on a chip (SoC) such as multicore processor arrays or combinations such as a DSP and a RISC processor together with various specialized programmable accelerators. A stored program in an onboard or external (flash EEPROM) ROM or FRAM may support or cooperate with the signal processing methods.

Glossary TABLE 1 provides some introductory description about some video decoding concepts used in some of the embodiments and adapted from the following cited 330-page document, which has extensive H.264 definitions, decoding processes, derivation processes and specifications. Background on H.264 coding is publicly available from the International Telecommunication Union (ITU-T), see:

### International Telecommunication Union ITU-T H.264

### Telecommunication Standardization Sector Of ITU (03/2005)

### Series H: Audiovisual and Multimedia Systems

Infrastructure of audiovisual services—Coding of moving video
Advanced video coding for generic audiovisual services
http://www.itu.int/rec/T-REC-H.264/en

Reference software for H.264/AVC is publicly available from Fraunhofer Institute, Heinrich Hertz Institute at http://iphome.hhi.de/suehring/tml/download/.

TABLE 1
GLOSSARY

| | |
|---|---|
| Byte-aligned: | A leading position of a bit or byte or syntax element in a bit stream that is an |
| | integer multiple of 8 bits from a first bit in the bit stream. |
| CABAC: | Context Adaptive Binary Arithmetic (CABAC) in H.264 encoding and decoding |
| | compresses or decompresses a binarized video bit stream using binary arithmetic coding. The |
| | least probable symbol LPS and most probable symbol MPS respectively are assigned starting |
| | probabilities that are called contexts, and are adapted continuously based on whether a zero or a |
| | one was encountered in the previous cycle. |
| CBP: | Coded block pattern. |
| CPB: | Coded picture buffer. |
| Chroma: | Color intensity data for each set of one or more pixels per intensity datum and |
| | collectively forming a block for a given color component in an image. Chroma blocks include |
| | such color intensity information, e.g., one chroma block for a first color Cr and one chroma |
| | block for a second color Cb in the image. |
| Emulation prevention byte: | Whenever a series of bytes in an NAL unit in an encoded bit stream |
| | would be the same as a specified start code prefix that prefixes an NAL unit, then in a further |
| | emulation prevention part of the encode process, a byte = 0x03 is inserted into the bit stream so |
| | that the resulting series of byte-aligned bytes in an NAL unit no longer are the same as the start |
| | code prefix. That way, no series of bytes in the NAL unit can otherwise emulate (accidentally be |
| | the same as) the start code prefix. On decode, each such emulation prevention byte = 0x03 is |
| | removed. |
| ECD: | Entropy Coder and Decoder |
| Entropy coding: | Employs fewer bits to encode more frequently used symbols and more bits to |
| | encode less frequently used symbols, thus reducing amount of data to be transmitted, received |
| | and/or stored. Entropy coding process examples include 1) context-adaptive variable-length |
| | coding (CAVLC) such as Golomb decoding, and 2) context-based adaptive binary arithmetic |
| | coding (CABAC), for instance. |
| Inter: | In inter-frame prediction, data is compared with data from the corresponding location of |
| | another image frame and may involve motion estimation. Inter-frame prediction facilitates image |
| | compression when a series of frames are identical, or when most of the difference between |
| | frames involves translational motion of all, or one or more portions, of an image therein. |
| Intra: | In intra-frame prediction, data is compared with data from another location in the same |
| | image frame. Intra-frame prediction facilitates image compression when much of the image is |
| | spatially uniform or repeated spatially. |
| Golomb decoder: | A variable length decoder that is a form of entropy decoder. |
| LMBD: | Left-most bit detection (e.g., one (1)) and also a count of the number of left-most |
| | complementary bits (e.g., zero (0)). |
| Luma: | Black-and-white intensity information in the pixels of an image. |
| Macroblock: | Collectively refers to a block of luma samples and two corresponding blocks of |
| | chroma samples. Each block is an array of data describing an array of pixels in the picture, e.g., a |
| | 16x16 array of pixels may be described by a 16x16 luma block (or four 8x8 luma blocks) |
| | together with an 8x8 red chroma block and an 8x8 blue chroma block. |
| NAL unit: | Network Access Layer unit has leading bytes that describe the payload data to follow |
| | and the payload bytes themselves, designated RBSP (raw byte sequence payload). The RBSP |
| | includes emulation prevention bytes interspersed as necessary in the RBSP. |
| Quantization step (qp): | Relates to coarseness of quantization of transform coefficients. A rate- |
| | control unit generates the quantization step (qp) by adapting to a target transmission bit-rate and |
| | the output buffer fullness. A larger quantization step implies more vanishing and/or smaller |
| | quantized transform coefficients, which become transformed and encoded into fewer and/or |
| | shorter codewords and smaller bit rates and files. |
| RBSP: | The raw byte sequence payload can include a series of payload bytes, or be empty. In a |
| | bit stream, the RBSP has syntax elements followed by an RBSP stop bit that may have follow-on |
| | zero (0) bits to complete a byte. |
| Slice: | A set of consecutive single or paired macroblocks in a picture. A raster scan of a picture |
| | can have slice groups. A slice group has slices. A slice is a set of single or paired macroblocks. |
| Syntax element: | An element of data represented in a bit stream. |
| Syntax functions: | Functions that use a bit stream pointer to the position of a next bit to be read |
| | from the bit stream by the decoding process. Some examples: |
| me(v): | mapped Exp-Golomb-coded syntax element with the left bit first. |
| se(v): | signed integer Exp-Golomb-coded syntax element with the left bit first. |
| te(v): | truncated Exp-Golomb-coded syntax element with left bit first. |
| ue(v): | unsigned integer Exp-Golomb-coded syntax element with the left bit first. |
| Start code prefix or Start Code: | Three bytes equal to 0x000001 that prefix each NAL unit. |

By way of introduction, slice parsing is a serial problem in most entropy codecs and has many variations and features making slice parsing hard to commit to hardware. Additionally, slice parsing could be an ideal place in a video coding process flow for incorporating error resiliency and error detection techniques to control a main entropy encode and/or decode processor. However, error resiliency and error detection are computationally intensive tasks for a main, or general purpose, processor.

It is desirable to add more slices to improve the error resiliency as video coding can be decoupled at the slice level, and allocated to multiple processors. So the speed of slice and entropy decoding decides when the individual processors or cores of a multi-processor system or system-on-a-chip can start.

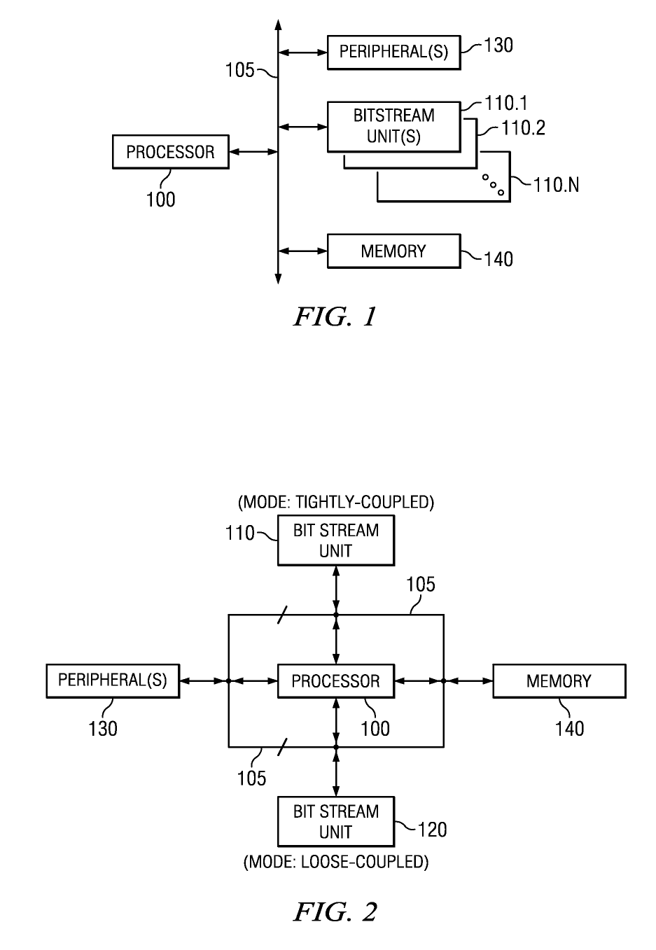

Here, various programmable slice processor architectures with one or more custom bit stream units are described. In FIG. 1, one or more bit stream units 110.1, 110.2, . . . 110.N are programmable through instructions and the programmer interface from a processor 100 on a bus 105, and these bit stream units 110.i can be used for all or most video and audio standards. Such bit stream unit 110.i is also useful for any or almost any type of header parsing, in TCP/IP and packet standards and anywhere information is packed into a sequential set of bits. Peripheral(s) 130 provide streaming video or other streaming content for efficient decoding or encoding by the bit stream units 110.i and processor 100. A memory 140 supports and stores the streaming video or other streaming content, intermediate quantities and information involved in the decoding or encoding, and the decoded or encoded output of the processor 100 and the bit stream units 110.i. For conciseness, details of memory 140, memory management and any caches and coherency circuitry are established as desired by the skilled worker and merely omitted from the illustration in FIG. 1.

Such a bit-stream unit 110.i is suitably provided in hardware for decoding of entropy coded symbols and, moreover, is leveraged in a programmable context for slice processing. For example, if slice processing is executed on even a high performance processor, the video performance is likely to be caused to drop in the presence of multiple slices.

Various of the embodiments are simple and uncomplicated to deploy, and they provide solutions that are vital to overcoming performance bottlenecks that have impeded the art.

A slice processor 100 contains or is coupled to each bit-stream unit 110.i. Dedicated hardware registers are integrated in some of the embodiments providing an operational mode or modes as a tightly-coupled unit into the processor 100 pipeline.

In FIG. 2, in some embodiments the processor 100 with bus 105 desirably is coupled with two such bit-stream units, so that one of the bit stream units 110 operates in a loosely coupled manner and another one of the bit stream units 120 operates in a tightly coupled manner. Start code detection is herein recognized to be a sequential process best executed in a loosely coupled process, and parsing of the NAL unit is recognized to be best executed in a tightly coupled process.

In loosely coupled operation as described herein, the processor 100 issues a Command to detect the next start code, whereupon the loosely coupled bit-stream unit 120 proceeds autonomously and independently of processor 100 to process the incoming bit stream. Processor 100 is free to execute other tasks during this time. Eventually, the bit stream reaches a point at which unit 120 finds the next start code in the bit stream and returns the length in bytes of a packet preceding the start code.

Processor 100 then starts issuing Instructions to tightly coupled unit 110 that parse the NAL unit that precedes or is prefixed by the just-detected start code. (A subset of these Instructions or a field in one or more of them are in some cases called Requests herein.) In tightly coupled operation as described herein, the CPU issues the Instructions and the tightly coupled bit stream unit herein quickly returns parsed results, while the CPU continually monitors for such returns of results and uses the parsed results on a continuous basis.

Two units 110 and 120 are used in FIG. 2, so that while one bit stream unit 120 is detecting the length of a second NAL unit, another bit stream unit 110 parses a first NAL unit for the individual elements of the slice. The system thereby continually decodes a slice in unit 110 without its being bogged down with NAL unit detection that is instead handled by loose-coupled unit 120.

Using one or more bit stream units 100 as taught herein can speed up processing of SPS (Slice Parameter Set), processing of PPS (Picture Parameter Set), and processing of a Slice Header. Bit stream units 100 and plural sub-units 110.i act as accelerators by reducing by more than a hundred-fold the roughly 10̂5 number of cycles that would otherwise be consumed by a conventional programmable processor to do all that processing. Various embodiments can provide various benefits and advantages while delivering greater or less than such speed-up or cycle reduction.

The embodiment in FIG. 2 is expected to confer an expected speed up as tabulated in TABLE 2. Bit stream processor processing cycle estimates are provided in TABLE 2 for processing the 1) PPS header 2) SPS header 3) Slice header.

TABLE 2
SPEED UP TABULATION

| | Normal | | |
|---|---|---|---|
| | Processor | With Bit_stream Unit * | SpeedUp |
| SPS processing+: | 198618 cycles | 200 cycles | 993x |
| PPS processing+: | 166761 cycles | 776 cycles | 214x |
| Slice Header | 98906 cycles | 265 cycles | 373x |
| processing: | | | |

+SPS stands for Slice Parameter Set.
+PPS stands for Picture Parameter Set.
*Estimate based on above assumptions

Benefits and solved problems conferred by some embodiments herein include any or all of the following, among others: 1) Various embodiments make contributions to encoding/decoding HDTV images and other image types in real-time, 2) substantial processor cycle reductions, 3) substantial increase in system speed, 4) more efficient entropy encoding, 5) more efficient decoding of entropy coded symbols, 6) programmable efficient slice processing for high and sustained video performance in the presence of multiple slices, 7) separating NAL unit length detection from slice decoding.

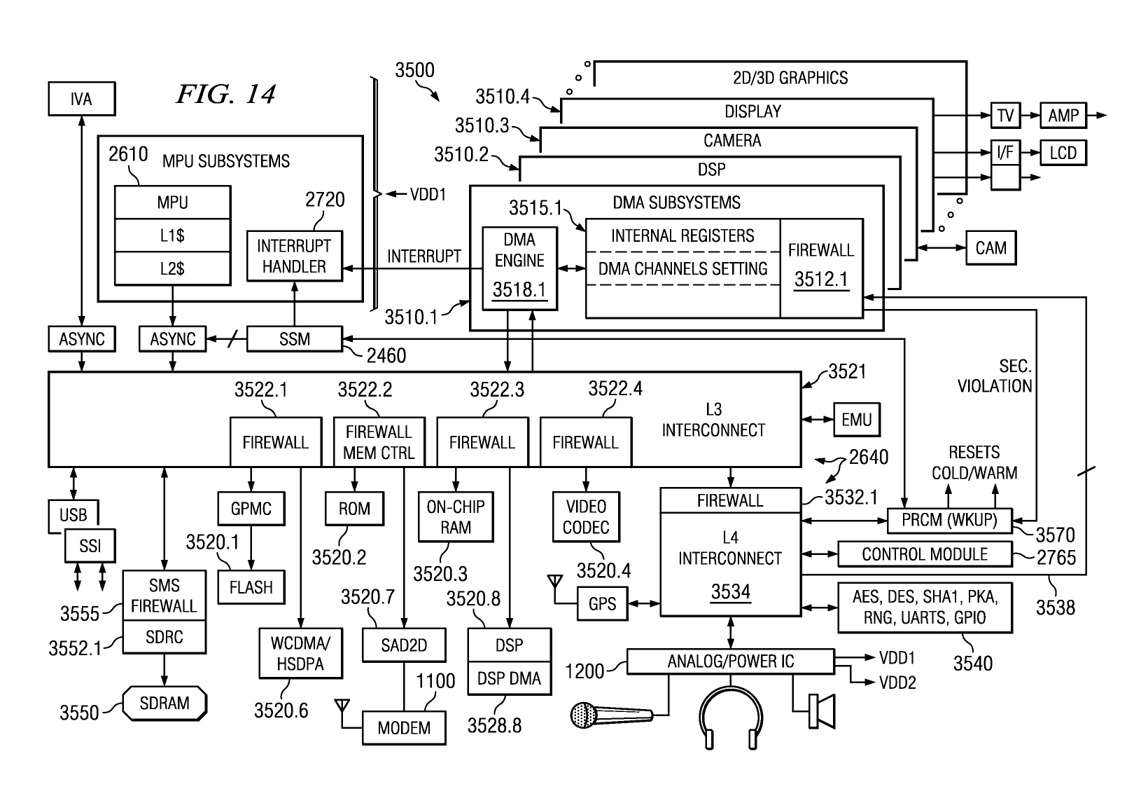

Embodiments based on FIGS. 1 and 2 can be variously provided so that NAL unit detection is handled by separate hardware from slice parsing. For instance, in another embodiment, processor 100 does the NAL unit detection and two or more bit stream units 110.i decode multiple slices in parallel and are each made tightly coupled with processor 100. Processor 100 can be a RISC processor like processor 2610 of FIG. 14. In still another embodiment, programmable processor 100 sends a Command to a loose-coupled dedicated-hardware bit stream unit 110.1 to do the NAL unit detection, and processor 100 sends Instructions to two or more bit stream units 110.2, 110.3, etc. each having their own dedicated-hardware made tightly coupled with processor 100 to decode multiple slices in parallel.

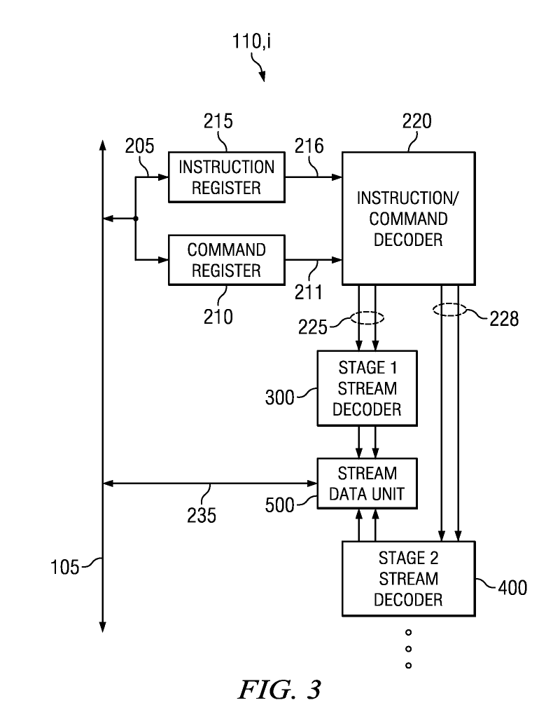

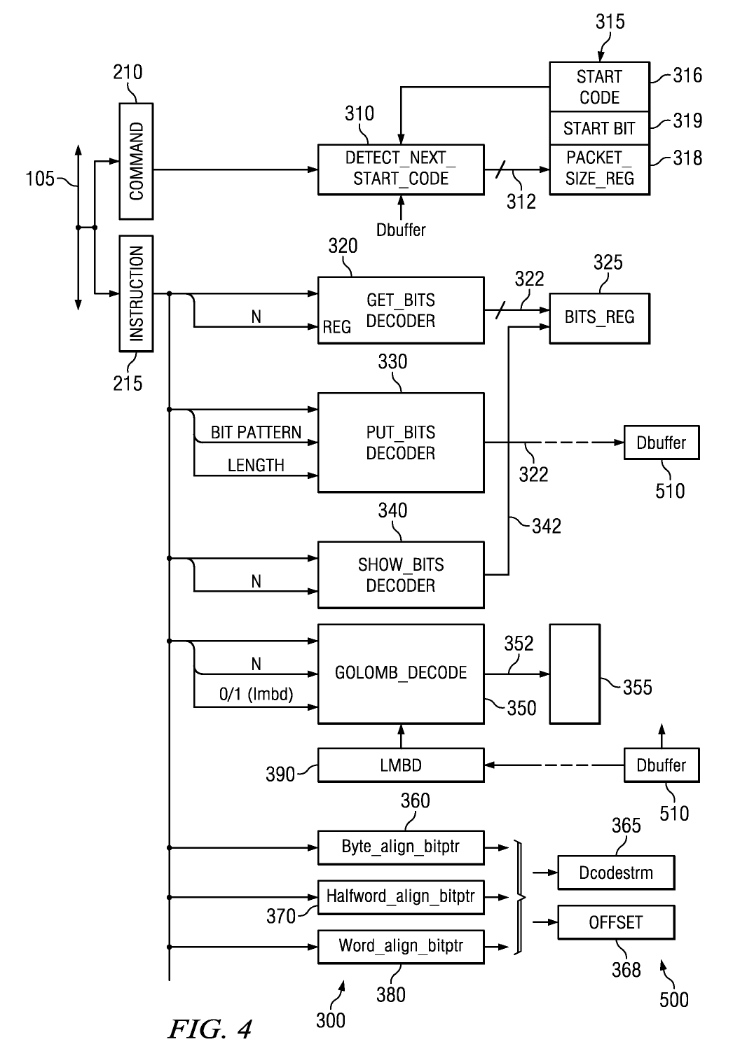

In FIGS. 3 and 4, a remarkable loose-coupled Commands architecture embodiment herein is different from an execution unit that has delay slots. The Commands architecture provides and operates as an almost autonomous unit, which a host processor 100 or other processor checks on before using that unit 110.i at the next time or some subsequent time. The host processor has processor delay slots and can remarkably issue at least one Instruction for tightly-coupled support for stream encoding or decoding wherein an Instruction as taught herein is suitably executed during one or more such processor delay slots. Moreover, host processor 100 is operated to issue a Command for loose-coupled support, and bit stream hardware as taught herein responds to such command for substantially autonomous operation independent of the processor delay slots to provide accelerated processing of the bit stream.

In another embodiment, blocks 210, 310, 315 from FIG. 4 are provided into one loose-coupled bit stream unit 110.1 and the rest of the FIG. 4 blocks 215, 320-390 are provided into each of one or more tightly-coupled bit stream units 110.2, 110.3, etc.

In FIG. 3, bus 105 is coupled by bus lines 205 to a Command register 210 and an Instruction register 215. Bit stream unit 100.i thus has a bus 205, separately-accessible registers 210 and 215 respectively coupled to bus 205 to enter such a Command and to enter such an Instruction. Further, a decode circuit 220 is coupled by respective input lines 211 and 216 to registers 210 and 215. Decode circuit 220 responds to such a Command to operate a first stage stream decoder 300 using control lines 225. Decode circuit 220 responds to such an Instruction to operate a second stage stream decoder 400 using control lines 228. A stream data unit 500 in bit stream unit 100.i is shared by both the first stage stream decoder 300 and the second stage stream decoder 400. Stream data unit 500 is coupled by bus lines 235 to bus 105 to receive start codes and NAL units. Also, registers in stream data unit 500 are accessible by processor 100 to obtain results of Commands and Instructions.

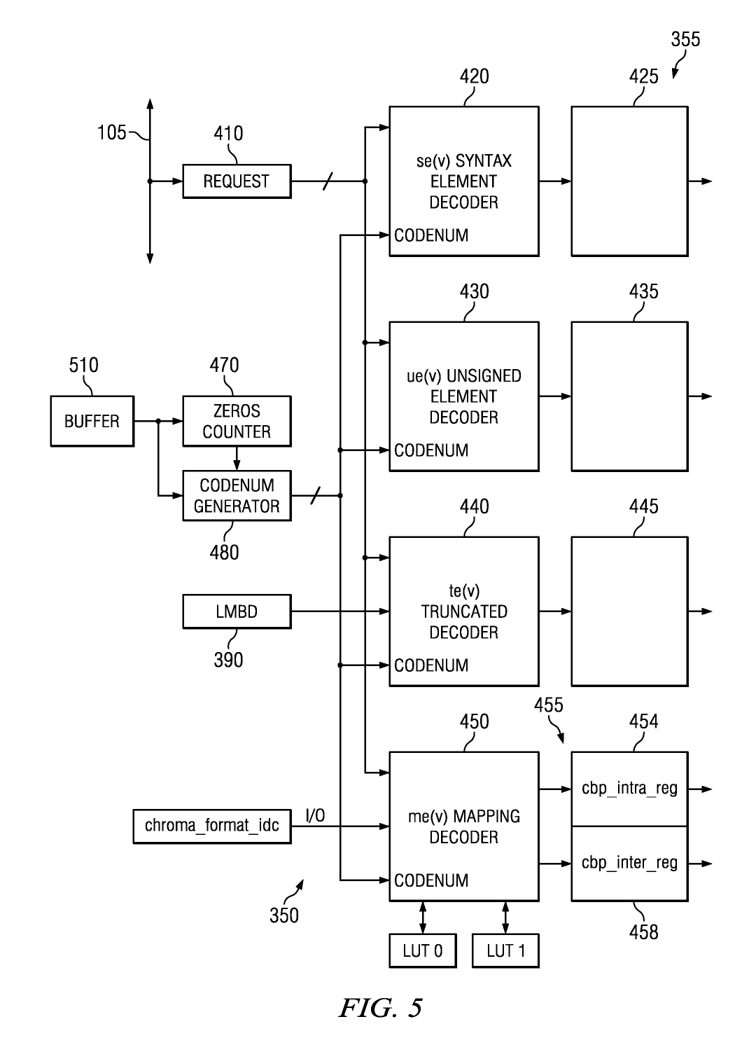

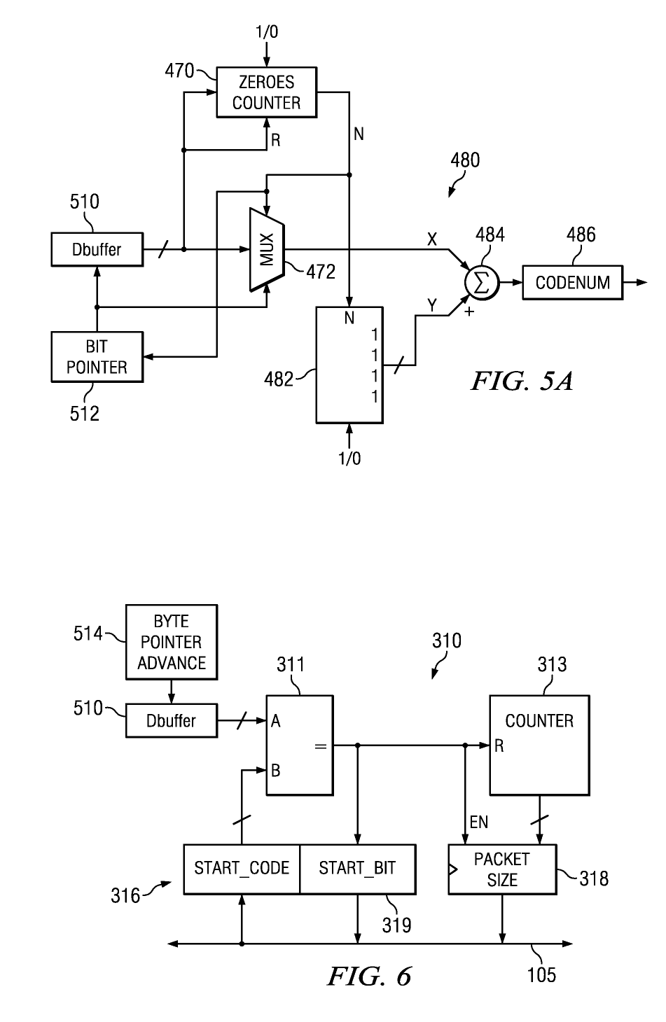

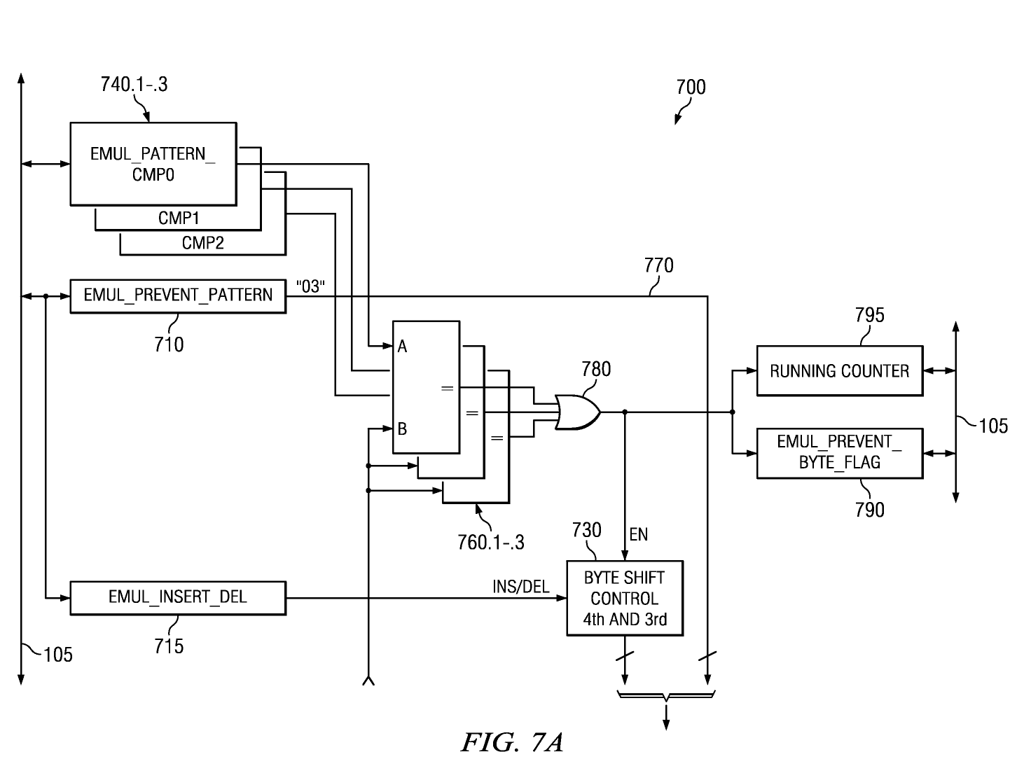

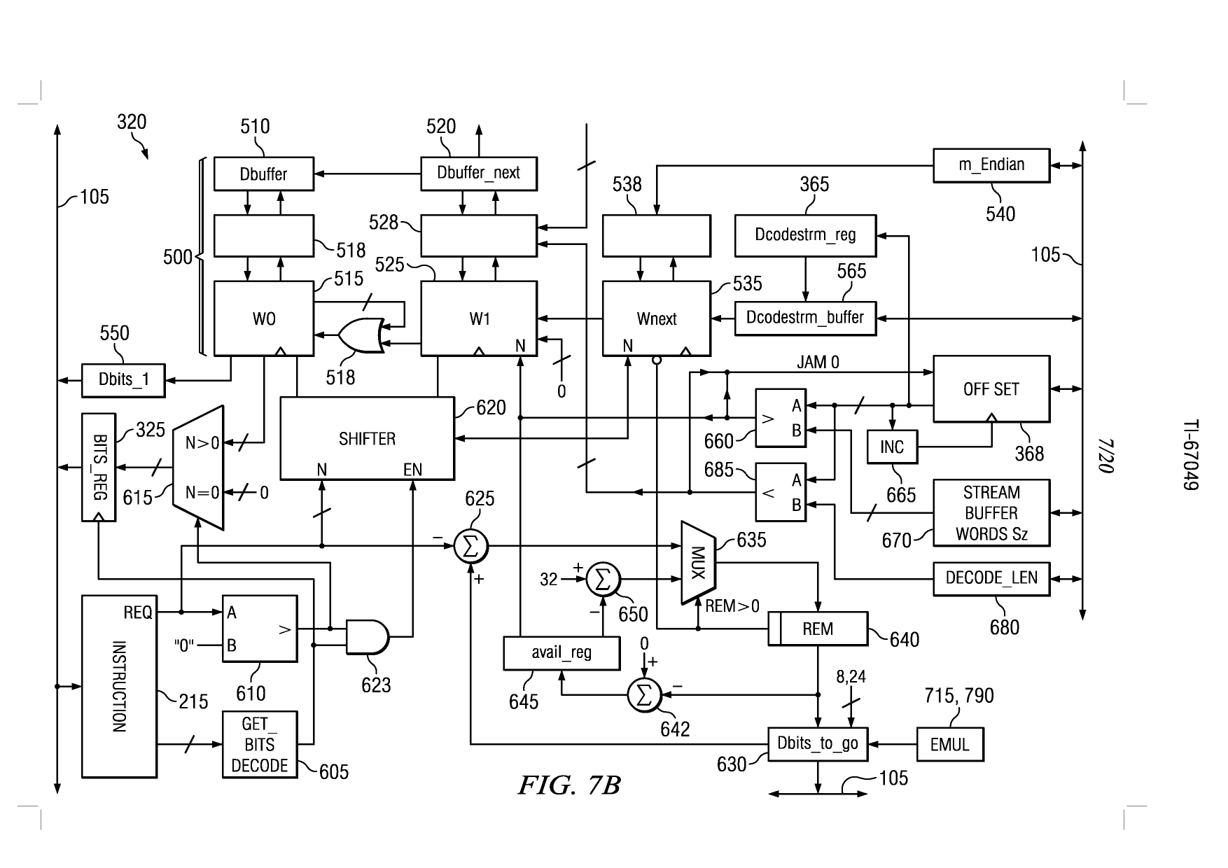

In FIGS. 4 and 5, consider the difference between a Command and an Instruction as used herein. A Command is issued to an autonomous unit or portion of a bit stream unit, which then goes off and executes an asynchronous process independent of processor delay slots or other operations. The issuing processor 100 polls, for instance, to check whether performance of the Command is completed. Alternatively the issuing processor can receive an event or interrupt notification if it so chooses. By contrast, Instructions are issued one by one and processor 100 and/or its software has built-in knowledge of when to issue next instruction and may provide delay slots such as NOPs or instructions to advance other functions, while waiting for the accelerator to return results of executing the Instruction. Request herein depends on context and refers to 1) a requested number of bits in FIG. 7A such as may be a field in, or an accompanying parameter for, one or more of the Instructions or 2) a subset of the Instructions asking for te, me, ue, or se as in FIG. 5. If desired, FIG. 5 register 410 may also be labeled Instruction instead of Request, whereby to leave the term Request to refer to the Instruction field req for requested bits output from Instruction register 215 of FIG. 7B, 9 or 10.

In FIG. 4, a remarkably-versatile bit-stream unit for slice processing has hardware registers such as in TABLE 3 and is integrated on the Instruction side as a tightly coupled unit into the processor pipeline, and is associated to the processor 100 on the Command side as a loosely-coupled unit.

In FIG. 4, a Command from bus 105 is coupled to command register 210 that in turn controls operations of a hardware block 310. Hardware block 310 detects the next start code from a series of bits from the bit-stream held in a data buffer Dbuffer. A start code output register 315 is fed on lines 312 from block 310 and has a START Bit field 319 that signifies valid detection of a start code, well as a Packet_Size_Reg field that indicates the size in bytes of an NAL unit that is preceded or prefixed by the start code. This Command circuitry 210, 310, 315 serves processor 100 as a loosely-coupled unit.

In FIG. 4, an Instruction from bus 105 is coupled to instruction register 215 that in turn controls operations of a currently-applicable one of numerous instruction-specific hardware blocks 320-380. The instruction-specific hardware blocks have decoding logic to decode the current instruction bits in the instruction register 215 into one or more controls to activate circuitry in the block that performs operations on the bit-stream that the instruction bits represent. The instruction-specific hardware blocks include the following:

A Get_bits decoder 320 is coupled by output lines 322 to a register Bits_Reg 325 into which removed bits from the bit-stream are entered in accordance with a Get_bits instruction. A Req input of Get_bits decoder 320 is fed a number N representing the number of bits to get or remove.

A Put_bits decoder 330 is coupled by output lines 332 to a buffer register Dbuffer 510 by which register bits are inserted into the bit-stream in accordance with a Put_bits instruction. Put_bits decoder 330 has input lines to receive three fields from instruction register 215: 1) an instruction field for Put_bits instruction to activate the decoder, 2) a bit pattern field to provide the bits to be inserted into the bit stream, and 3) a length field specifying the number of bits to be inserted into the bit-stream.

A Show_bits decoder 340 is coupled by output lines 342 to Bits_Reg 325 and returns the top N bits of the bit-stream, without advancing the pointer, in accordance with a Show_bits instruction. An input of Show_bits decoder 340 is fed a number N representing the number of bits to show.

A Golomb_Decode block 350 is coupled by output lines 352 to a decode output register set 355. Golomb_Decode block 350 has input lines to receive three fields from instruction register 215: 1) an instruction field for a Golomb decode instruction to activate the decoder, 2) a length field N specifying the number of bits to be Golomb decoded, and 3) a 0/1 field to activate and/or configure a leftmost bit detector LMBD 390 fed from data buffer Dbuffer 510.

A set of instruction specific decoders Byte_align_bitptr block 360, Halfword_align_bitptr block 370, and a Word_align_bitptr block 380 supply a respective output from the currently-activated one of the blocks 360, 370, 380 to registers Dcodestrm 365 and Offset 368 as described in TABLE 3 and elsewhere herein. Basically, these decoders move the data buffer pointer to a byte aligned, halfword aligned, or word aligned position respectively. In this way, further Instructions Byte_align_bitptr( ), Halfword_align_bitptr( ), and Word_align_bitptr( ) are respectively decoded and byte-align the pointer, half-word align the pointer, or word-align the pointer.

Glossary TABLE 3 provides a description of hardware registers in the bit stream units of FIGS. 4 and 7A and 7B. The registers, register fields or data structures in bit stream unit 110.i carry the state variables or parameters that pertain to the arithmetic decoder and are described as follows.

TABLE 3
GLOSSARY FOR BIT STREAM UNIT

| | |
|---|---|
| TI_Dec_Data: | This data structure carries all the state variables that pertain to |
| | the arithmetic decoder. Specifically, the fields of the structure |
| | are defined as follows: |
| Dbuffer: | The first register that holds upper 32-bits of bit stream. |
| Dbuffer_next: | This register holds next 32 bits of bit stream. |
| Dbits_to_go: | Count of the number of valid bits in Dbuffer_next. |
| | Valid range for Dbits_to_go is from 1 to 32, with refill of |
| | Dbuffer_next happening any time requested bits is larger than |
| | Dbits_to_go. |
| Dcode_len: | Length of the bit stream buffer. Used to ensure a read is always at an |
| | offset smaller than Dcode_len and rewind back to 0, implementing a |
| | circular buffer. A circuit in the TI_Get_bits block suitably performs |
| | this check. |
| Dbits_1: | Leftmost 1-bit look ahead to handle the case of equi-probable decoding. |
| | Doing this speculative lookahead of 1-bit obviates executing a function |
| | get_bits of 1, during equi-probable decode. |
| Dcodestrm_ptr: | Pointer to the arithmetically compressed Dcodestrm_buffer array. |
| Offset: | Offset to the Dcodestrm_buffer array from which data is read. |
| Emul_prevent_pattern: | Emulation prevention pattern, e.g. “03”, |
| | see FIG. 7B register 710. |
| Emul_prev_byte_flag: | Emulation prevention byte flag active indicates the |
| | emulation prevention pattern is detected in a packet. |
| Emul_pattern_cmp0, 1, 2: | Different values are held in these three register fields |
| | as bit sequences that are at risk to be mistaken for the start code |
| | 0x000001 by start code detector 310 when monitoring the bit stream. |
| | Emulation prevention pattern insertion is applied on encode if any |
| | one of these values is detected. |
| m_Endian: | The register bit or field specifies whether the endian (bit ordering) for the |
| | circuitry is big endian or little endian. |

More description of FIG. 4 is detailed in FIGS. 5-10B.

Turning to FIG. 5, Golomb_Decode block 350 and decode output register set 355 of FIG. 4 are detailed. Bus 105 is coupled to a request register 410 that holds a Request. As noted hereinabove, a Request can be an Instruction or a field of an Instruction in register 215 of FIG. 4. In FIG. 5, the request register 410 holds a current request that has the correct bits to activate one of the request-specific decoders 420, 430, 440, or 450. These request-specific decoders execute a selected one of functions se(v), ue(v), te(v), me(v) to support Golomb decoding. See TABLE 1 and description later hereinbelow.

Each decoder 420, 430, 440, 450 has a Request input, and an input for a value CodeNum and has an output to a respective output register 425, 435, 445, 455. A zeroes counter 470 counts zeroes in the bit stream from data buffer Dbuffer 510. A code number generator 480 is fed by zeroes counter 470 and Dbuffer 510 and in turn supplies a CodeNum output. The CodeNum output from code number generator 480 goes to the input for the value CODENUM of each decoder 420, 430, 440, 450. CodeNum is produced in a remarkably efficient structure and process supportive of the coding or decoding process to be executed, an example of which is described hereinbelow. Decoder 440 for function te(v) has a third input fed by LMBD 390. Decoder 450 for mapping function me(v) has a third input fed with a I/O value chroma_format_idc. Decoder 450 is coupled to a pair of lookup tables LUT0 and LUT1, and Decoder 450 supplies output to register(s) 455 for Intra and Inter coded block pattern cbp_intra_reg 454 and cbp_inter_reg 458.

In FIG. 5, certain H.264 syntax elements unsigned integer ue(v), mapped me(v), or signed integer se(v) are exponential Exp-Golomb-coded. Syntax elements te(v) are truncated Exp-Golomb-coded. All have left bit first. Slice processing across video standards involves repeated requests for decoding of codes like Golomb codes that involve syntax elements such as se(v), ue(v), te(v), and me(v).

The parsing process for these syntax elements begins with Zeroes Counter 470 reading the bits starting at the current location in the NAL unit payload RBSP part of the bit stream from Dbuffer 510 up to and including the first non-zero bit, and counting the number of leading bits that are equal to 0.

Basically, in Exp-Golomb encoding, each CodeNum value in the set {0, 1, 2, 3, 4, 5, 6, 7, 8, . . . } has a corresponding Exp-Golomb code {1, 010, 011, 00100, 00101, 00110, 00111, 0001000, 00010001, . . . }. The Exp-Golomb code is a variable length code that, for any given value of CodeNum originally encoded by an encoder, provides a string of leading zeroes (or none) terminated by “1” and followed by data bits equal in number (or none) to the number N of leading zeroes. See hereinabove-cited H.264 at section 9.1 “Parsing process for Exp-Golomb codes,” Tables 9-1 and 9-2 that show in their own way how Exp-Golomb code is organized. The data bits represent a binary number X, e.g., three data bits “101” represent the number 101 binary, which is 5 in decimal.

In FIGS. 5 and 5A, on decode, Zeroes Counter 470 counts the number N of leading zeroes to signify to CodeNum generator 480 how many pertinent data bits in the Exp-Golomb code in Dbuffer 510 will follow the “1” that terminates the leading zeroes string. CodeNum generator 480 has a mux circuit 472 that responds to Zeroes Counter 470 number N and a bit pointer 512 by selecting those data bits from Dbuffer 510, and those data bits represent the binary number X. Zeroes Counter 470 counts the number N of leading zeroes to also signify to CodeNum generator 480 how to obtain a number Y to which X is added. The number Y is exponentially related to the number N of leading zeroes according to Y=(2^{N}−1). In CodeNum generator 480, a circuit 482 has a set of zero-qualified bit inverters or simply a hardware generator of an N-wide field of ones (1×111) to form Y=(2^{N}−1) by either inverting the N leading zeroes or simply providing an equal number N of hard-wired ones to constitute Y. (If the bit stream code instead uses leading ones terminated by a zero, as indicated by a mode input “1/0”, then Zeroes Counter 470 counts ones, and circuitry 480 is configured and arranged as appropriate to accommodate any other aspects of the particular bit stream code employed.) CodeNum generator 480 also includes a hardware adder 484 and register 486 to electronically execute and enter the sum X+Y to deliver as CodeNum to syntax element decoders 420-450. CodeNum generator 480 also advances the bit pointer 512 by an amount N+1 (the “1” followed by the number N of data bits that equal the counted number N of zeroes). The Zeroes Counter 470 is reset at its reset input R by the first “1” that terminates the leading zeroes string. Zeroes Counter 470 subsequently begins anew, counting leading zeroes (or none) from the next Exp-Golomb code starting with the bit position just after those data bits.

In this way, Zeroes Counter 470 provides an example of a leading bits circuit operable to identify how many leading bits are terminated by an opposite-valued bit in an entropy code. Code number circuit 480 responds to that leading bits circuit to select an equal number of data bits that follow that opposite-valued bit and to generate an electronic representation of a number in response to the leading bits and those data bits jointly, thereby to evaluate the entropy code.

Further in FIG. 5, the signed element se(v) decoder 420 hardware herein in one version suitably accomplishes the decoding of se(v) by table look up in a lookup table LUT2 (not shown), once CodeNum is obtained from CODENUM generator 480. Decoder 420 with LUT2 takes two (2) clock cycles. CodeNum is a positive integer in the set {0, 1, 2, 3, 4, . . . } Decoder 420 looks up in LUT2 for the corresponding se(v) value respectively in the set {0, 1, −1, 2, −2, . . . }. Values for LUT2 are pre-entered based on the video coding standard, see e.g., the hereinabove-cited H.264 at section 9.1.1 “Mapping process for signed Exp-Golomb codes” Table 9-3. Alternatively in decoder 420, and to save some cycle time and to save some integrated circuit space by omitting LUT2, decoder 420 is instead provided with a decode logic circuit with a few logic gates connected for single-cycle decoding from CodeNum to se(v). Such decode logic circuit forms signed element se(v) as a binary number with a leading default-positive sign bit and passes all CodeNum bits except its LSB bit to form the output bits of that binary number se(v) to register 425. To set the sign bit when the sign is to be negative, the decode logic circuit uses the LSB of CodeNum to toggle or flip the sign bit in register 425 from default positive to a negative sign if that LSB is one. Other logic is suitably provided if desired, depending on the particular manner of representing a signed binary number adopted for the hardware in the system.

In FIG. 5, the unsigned element ue(v) decoder 430 hardware herein passes all the bits in the value of CodeNum input itself as the output ue(v) to register 435 (CodeNum register 486 may be reused as register 435). The processor 100 has already sent the Instruction including the Request for ue(v) and has a delay slot or cycle for the ue(v) decoder single cycle time in FIG. 5, whereupon processor 100 accesses the resulting ue(v) from register 435. In this way ue(v) provides an Unsigned int bit_field=Golomb_decode (N). Counter 470 performs a left-most bit-select of either ‘1’ or ‘0’ on Dbuffer 510, depending on a mode “1/0” input appropriate for the bit stream code and then requests that many lmbd bits, returning a string of length 2*lmbd+1 for evaluation as in FIG. 5A or otherwise-suitable circuitry. This instruction maps to ue(v). In some embodiments, if desired, ue(v) decoder 430 also sets a valid bit in register 435 to indicate when its contents are valid. Some embodiments couple two or more of the decoders 420-450 to share a same output register and enter the output from the particular decoder 420, 430, 440, 450 activated by the Request 410.

In FIG. 5, te(v) decoder 440 hardware has a logic circuit with an input fed by LMBD 390 and outputs, with the flip of the bit if lmbd is 1, its te(v) output to register 445 in a single clock cycle. The syntax element te(v) refers to truncated unary exponential Golomb code, and is decoded like ue(v) for all cases where it is less than 1. If LMBD 390 supplies an lmbd output value greater than one, a logic circuit in decoder 440 responds to lmbd>1 and qualifies gates to pass CodeNum itself to register 445. When lmbd=1, the logic circuit in decoder 440 instead decodes a single bit 0 into a value of 1, and decodes a single bit 1 into a value of 0. This logic operates in one clock cycle and thereby provides high performance while supporting hereinabove-cited H.264 at section 9.1 “Parsing process for Exp-Golomb codes” for te(v).

Further in FIG. 5, the me(v) decoder 450 maps the value of codeNum and the 0/1 state of chroma_format_idc to return a particular pair of coded block pattern (cbp) output values cbp_intra for Intra and cbp_inter for Inter. The pair of output values go to registers 454 and 458 herein for macroblock prediction modes Intra and Inter respectively. The two hardware lookup tables LUT0 and LUT1 in FIG. 5 are provided to respectively correspond to the cases of chroma_format_idc equal to 0 and chroma_format_idc not equal to 0. The LUT0 and LUT1 lookup table values are pre-loaded with values provided to support video coding such as values specified in hereinabove-cited H.264 at section 9.1.2 “Mapping process for coded block pattern,” Tables 9.4(a), 9.4(b) therein. Table look up by me(v) mapping decoder 450 uses the decoded codeNum from CodeNum generator 480. This table look up in LUT0 or LUT1 by me(v) mapping decoder 450 proceeds in parallel with the next bit-stream command. Even though me(v) mapping decoder 450 may have a latency of 2 cycles in this example, the over all Golomb_Decode circuit 350 is free to execute another Instruction or request on the second cycle so that the latency is hidden.

Turning to FIG. 6, Command-activated start code detection circuit 310 of FIG. 4 is detailed. Start code detection is performed by advancing a byte at a time under control of Byte Pointer Advance circuit 514, and using a comparator circuit 311 to examine if Dbuffer 510 has reached a start code like 0x000001, or 0x00000001. For this purpose, a Start_code register 316 is provided for processor 100 to program or configure as a control register(s). These register(s) can be re-programmed by the user to achieve start code detection by the user in an automatic fashion. Comparator 311 compares a start code in register 316 against Dbuffer and upon such detection sets a ‘1’ in the Start_bit register 319 so processor 100 can determine when a start code is detected. The circuitry 310 uses a counter 313 to track the number of bytes between two start codes, so that processor 100 can access the size of a packet or NAL unit from Packet Size output register 318.

In the FIG. 6 circuitry, the FIG. 4 block Detect_Next_Start_Code 310 has comparator 311 that looks for a match between a predetermined Start_Code field entered in register 316 and bytes in data buffer Dbuffer 510 to which Byte Pointer Advance circuit 514 points. The Start_Code field is suitably provided as an operand of the Command in Command register 210 of FIG. 4 or as Start Code field 316 as illustrated in FIGS. 4 and 6. The circuitry of FIG. 6 is an example of hardware that is activated upon entry of a Command having a bit field commanding detection of a next start code, and the detailed Command decode logic to activate the circuitry of FIG. 6 in response to such bit field of the Command is straightforwardly included in block 220 of FIG. 3 and block 310 of FIG. 4. Focusing on the circuitry of FIG. 6, when the byte pointer 314 advances to a place in the buffer 510 at which a match (=) with Start_Code 316 is detected by the comparator 311, then a Start_Bit 319 is activated to signal the processor 100 that a Start code prefixing a new NAL unit is found. In the meantime, during the previous NAL unit a counter 313 has been incrementing. The active match (=) from comparator 311 enables Packet Size register 318 to store the latest count from counter 313, whereupon counter 313 is reset due to the active match (=) from comparator 311 at the reset input R of counter 313. On the next byte pointer 514 advance, the reset to counter 313 is lifted and the counting starts anew without affecting the just-entered Packet Size value in register 318 until later when another active match (=) event from comparator 311 occurs.

In this way, FIG. 6 circuit 310 provides a Loosely Coupled Mode for the more extensive FIG. 4 bit stream unit embodiment. Processor 100 issues a Command to detect the next start code after the first start code is detected. The bit stream unit circuit 310 advances on its own, freeing processor 100 for other operations, until circuit 310 finds another start code and returns the length of the start code in bytes via Packet Size register 318. Until then, circuit 310 does not accept a new Command from the processor 100, as signaled by Start Bit 319 inactive. The processor 100 polls Start Bit 319 checking whether the start code detection completed or not. When processor 100 has verified that the start code detection for the start code of an NAL unit has completed, as signaled by Start Bit 319 active, then processor 100 issues a Command to circuit 310 to find a next subsequent start code and processor 100 starts issuing Instructions to register 215 pertaining to the NAL unit for which the start code detection completed. The decoders 320-380 of FIG. 4 responsively execute the new Instructions that come to register 215.

In FIGS. 7A, 7B and TABLE 3, an example of more detailed circuitry for the bit-stream unit of FIG. 4 continually and repeatedly obtains or maintains 64-bits of the bit-stream to be encoded or decoded in two registers Dbuffer 510, Dbuffer_next 520, a word offset into the bit-stream at Offset 368, a starting address entered in Dcodestrm_reg 365 for an access to memory or buffer Dcodestrm_buffer 565, and a partial bit-counter Dbits_to_go 630 in FIG. 7B. Dbits_to_go holds a value in a range from 0<=Dbits_to_go <=32.

Additionally, in the circuitry of FIG. 7B maintains m_Endian flag 540 that represents how the data should be presented in the Dbuffer 510 and Dbuffer_next 520 registers, i.e. in little endian or big endian format. A control circuit 538 is responsive to the m_Endian flag 540. Video bit-streams are generally big-endian and thus handle data from left to right, i.e. higher numbered address is a lower numbered byte.

FIG. 7A shows a structure and process described firstly for handling of emulation prevention removal on decode when a register Emul_Insert_Del 715 is configured for byte removal (delete mode Del). A set of comparators 760.1, 760.2, 760.3 compares the data being read from a data buffer Dbuffer_next 520 of FIG. 7B against any of a plurality (e.g. three) of bit patterns that may include an emulation prevention byte 0x03. These bit patterns are pre-stored by processor 100 beforehand in a set of registers 740.1, .2, .3 that are also designated Emul_Pattern_Cmp0, 1, 2 herein. For example, such bit patterns embedded in a bit stream to be decoded could be any of 0x00000301, 0x00000302, and 0x00000303 in H.264, so these are pre-stored in registers 740.1, .2, .3. If there is a match by any of the comparators 760.1, 760.2, 760.3, a respective comparator 760.i output (=) goes active and, via an OR-gate 780, enables a shift register with byte shift control circuit 730. The Del state of register Emul_Insert_Del 715 activates the circuit 730 for emulation prevention byte removal.

In FIGS. 7A and 7B, circuit 730 shifts the last byte of Dbuffer_next 520 into the 3^{rd} byte of Dbuffer_next 520, which removes the emulation prevention byte from Dbuffer_next 520. The circuitry of FIG. 7A thereby performs emulation prevention removal wherein, for example, the patterns 0x00000301, 0x00000302, and 0x00000303 before removal become 0x000001, 0x000002, and 0x000003 after removal. In order to accomplish this emulation prevention removal, note that data buffer Dbuffer_next 520 is suitably read as a 32-bit value, and either all 32-bits are retained, or 24-bits are retained and represent a deficiency of 8-bits relative to a full 32-bit word. In the event that only 24 bits are retained, the entry in FIG. 7B register Dbits_to_go 630 is adjusted to 24 instead of the value 32 that is the normal case (32) during a complete word read. The deficiency of 8-bits is replenished in a follow-on buffer operation in FIG. 7B using bits Wnext.

A subsequent bit-request goes through the following hardware as defined by C code:

Dbits_to_go −= bits_req; //decrement Dbits_to_go by # bits requested

| | |
|---|---|
| bits_req | = bits_req + (emul_prev_byte_flag) ? 8: 0; // remove |

emul byte if flag set.

| | |
|---|---|
| bits_req | &= 31; // keep request modulo 32. |

Dbuffer = Dbuffer_next;
Dbuffer_next = get_bits (bits_req);

Emulation prevention removal as above is configured by processor 100 entering a Del state into configuration register 715, and then the emulation prevention circuit 700 monitors the bit stream and dynamically sets and resets a flag in emul_prev_byte_flag register 790. Any time a bit pattern including the emulation prevention byte is detected by any of comparators 760.i via OR-gate 780, byte shift control circuit 730 is actuated to remove the respective byte. The active output from OR-gate 780 also dynamically sets the flag in emul_prev_byte_flag register 790 and increments running counter 795. In most cases since the bit-stream read is way ahead of the actual request, the processor 100 is unlikely to encounter a stall, as emulation prevention bytes are rare in the bit-stream and can be corrected without exposing the delay to the user.

In FIG. 7A, embodiments of structure and process are described secondly for handling emulation prevention insertion on encode when a register Emul_Insert_Del 715 is configured for byte insertion (insertion mode Ins). The structure also utilizes the three comparators 760.1, 760.2, 760.3 with match outputs to the three-input OR-gate 780. For example, the circuitry in FIGS. 7A and 7B can execute H.264-compatible emulation prevention insertion on encode by loading the register emul_prevent_pattern 710 with a specified value of an emulation prevention byte or pattern. In this circuit, processor 100 operation beforehand loads a register emul_prevent_pattern 710 with the emulation prevention byte 0x03 (“03” in FIG. 7A). Processor 100 also enters three values 0x000001, 0x000002 and 0x0000003 in the respective registers 740.1, 740.2, 740.3 named Emul_Pattern_Cmp0, Emul_Pattern_Cmp1, and Emul_Pattern_Cmp2. (Notice on encode these three values in registers 740.i lack the “03” and so are not quite the same as the patterns entered for decode purposes and discussed earlier hereinabove.) Comparators 760.1, 760.2, 760.3 compare the first three bytes of Dbuffer_next 520 of an outgoing bit stream to each of these three values 0x000001, 0x000002 and 0x0000003 in parallel. This is because any of these bit sequences might otherwise be mistaken for the start code 0x000001 by start code detector 310 on an ultimate decode later unless emulation prevention insertion be provided on encode here. If any of the match outputs from comparators 760.1-.3 are active, byte shift control circuit 730 coupled with logic 528 of FIG. 7B inserts emulation prevention pattern 0x03 (“03” in FIG. 7A) from register 710 into Dbuffer_next 520 to create 0x00000301, 0x00000302, or 0x000000303, as the case may be, with circuit economy and high performance.

When an emulation prevention byte is inserted, emul_prev byte_flag 790 is set to 0x1 and then reset when a subsequent part of the bit stream is encountered that lacks any match. Also, a running count of insertions on encode is maintained by a counter 795 for access and data tracking when called for by debug software on processor 100. During encoding a 24-bit pattern becomes a 32-bit pattern, in which case the last byte that could not make it into the buffer immediately forms the first 8-bits of Dbuffer_next, and Dbits_to_go 630 is set to 8.

In this way, as described for FIG. 7A hereinabove, incoming bits for decode are automatically checked for emulation prevention codes to remove them, and outgoing bits from encoding have emulation prevention codes inserted. Compare H.264, section 7.4.1, which forbids 3-byte 0x000000, 0x000001, and 0x000002 in an NAL unit at a byte-aligned position, and forbids a byte-aligned 4-byte sequence having 0x000003 except for 0x00000300, 0x00000301, 0x00000302, and 0x00000303. Compare H.264 Annex B section B.3 on decode to discard emulation prevention byte (0x03) when a 3-byte 0x000003 occurs.

Focusing on FIG. 7B, in a tightly coupled mode, the processor 100 issues Instructions and monitors the results on a continuous basis. Instructions for the bit-stream unit 110.i in the tightly coupled mode are further described next. In FIG. 4, the following Instructions have single cycle behavior, when the memory referred to by Dcodestrm is a tightly coupled memory. Memory speeds on the order of hundreds of MegaHertz (MHz) are beneficial and useful for slice processing:

a) unsigned int bit_field=get_bits (N)

Returns a bit-field whose length N is such that 0<=N<=32.

The order of the bytes in the register bit_field depends on the m_Endian flag.

b) put_bits (bit_pattern, length)

Inserts a bit-field Bit_pattern, given by Length such that 0<=Length <=32, into the existing bit-stream. This feature is useful for debug so known patterns can be inserted and read back as needed.

c) unsigned int bit_field=show_bits (N)

Returns the top N bits of the bit-stream, without advancing the pointer. This function helps in getting information ahead of actual processing and aids in preparing registers and data in advance.

For reader convenience a few identifiers from that above-cited Reference software for H.264/AVC (see zip file “jm-dec.73a[1].zip” in file “biaridecod.c”) are employed for describing the remarkable, distinct and extensive hardware-defining C code for certain embodiments herein. Such identifiers are: Dbuffer, Dbits_to_go, Dcodestrm; and the description herein controls the meanings applied to even those identifiers herein, however. Description now turns to the extensive specifics of these remarkable and distinct embodiments.

Various embodiments in addition to those shown herein may also be generated by using the respective C code listings herein as input to any appropriate hardware design language HDL software tool known to the art that outputs a netlist of hardware defined by the C code wherein such netlist is automatically generated by the software tool employed.

### Get Bits

The Get_bits(N) Instruction herein and its TI_Get_bits hardware in FIGS. 4 and 7B operate as a hardware function to get bits from 32-bit buffer Dbuffer 510 in the sense that the bits are placed in a separate register Bits_reg 325 in FIG. 7B and removed from the Dbuffer 510 bit stream so that the bit stream lacks the gotten-bits on completion of the TI_Get_bits hardware operations. TI_Get_bits hardware is a 2-stage pipeline, but capable of accepting a new request every cycle, allowing TI_Get_bits to work at the rate of 1 request/cycle. Speculative loads into buffer Dbuffer_next 520 are carried out on the next 32 bits while Dbuffer 510 and its access circuit 518 and backup register W0 515 are returning the requested number of bits via MUX 615 to Bits Register 325.

Compare with H.264, Section 7.2 discussion of a syntactical function read_bits(n), conceptually used as a syntactical function to read the next n bits from the bitstream and advance the bitstream pointer by n bit positions. By contrast, in FIG. 7B the hardware embodiment called TI_Get_bits delivers H.264 support but by its own distinct, remarkably efficient and versatile circuit and process. Also, do not confuse Get_bits(N) herein with hereinabove-cited Reference software for H.264/AVC usage of nomenclature “get_byte( )” defined as: Dbuffer=Dcodestrm[(*Dcodestrm_len)++]; followed by Dbits_to_go=7. Also, some background on a kind of get bits is provided in U.S. patent application Publication “Video Coding” 20080317134, dated Dec. 25, 2008 (TI-36672), which is incorporated herein by reference in its entirety.

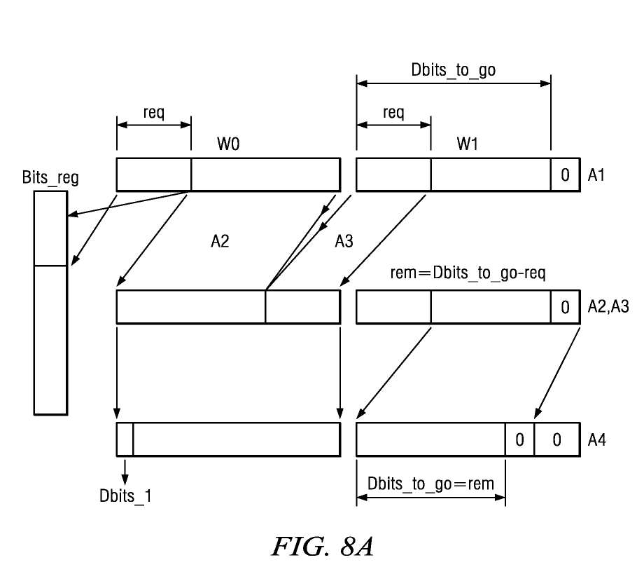

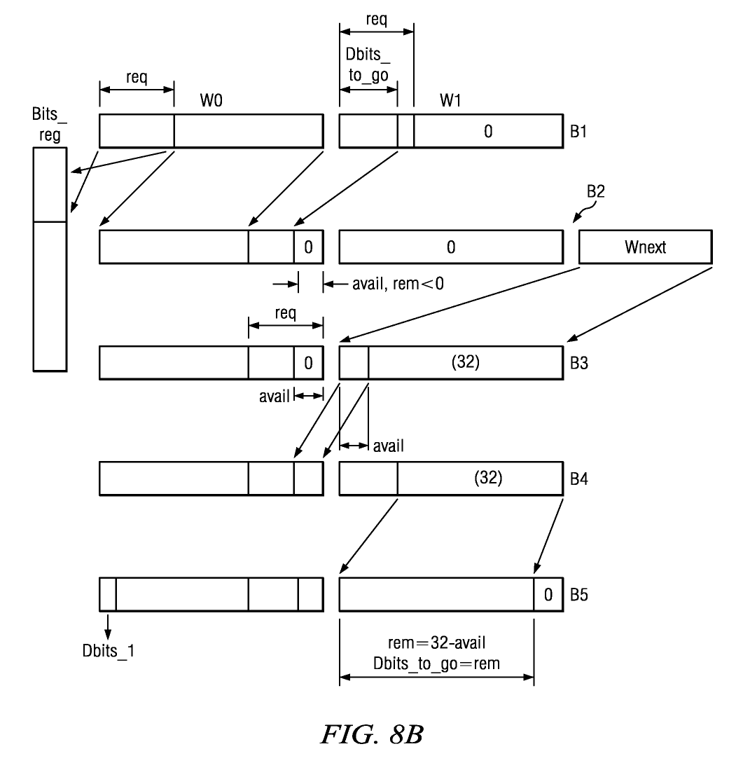

Hardware defining C code for an example of the remarkable TI_Get_bits embodiments herein is discussed next. Comments symbols /* and */ are omitted for line length textual comments. Some comments are preceded by IL Description for succeeding FIGS. 8A and 8B also details a process embodiment executed by the TI_Get_bits hardware.

Dcode_len register 680 in FIG. 7B holds the length of the bit stream buffer circuitry. A comparator 685 ensures that the Offset 368 for a read from the bit stream buffer is smaller than Dcode_len and otherwise rewinds the Offset 368 back to 0, implementing a circular buffer.

U32 TI_biari_dec_get_bits_32
(
U32 *Dbuffer,
U32 *Dbuffer_next,
U32 *Dcodestrm,
S7*Dbits_to_go,
S32 *offset,
U32 Dcode_len,
U4req,
U1*Dbits_1
)
{
U32 w0;
U32 w1;
U32 bits;
int rem;
U32 Wnext;
int avail;

Initially, write the Dbuffer into a temp buffer called w0 and Dbuffer_next into a temp buffer called w1.

| | |
|---|---|
| w0 = *Dbuffer; | //Transfer circuit 518 |
| w1 = *Dbuffer next; | //Transfer circuit 528 |

If no bits are requested, then return a 0 from Mux 615 and exit.

if (req==0) return (0);

In FIG. 7A, if req>0 at comparator 610, then Mux 615 muxes out and a shift circuit shifts the requested number of bits from w0 to the bits register 325. AND-gate 623 output becomes active in response to the Get_bits Instruction detected by decode 605 and req>0 at comparator 610. A shifter 620 responds to AND-gate 623 and shifts the remaining bits left by the requested amount and fills the empty bit locations in temp buffer w0 with the bits from w1 using an OR-gate circuit 518. Shifter 620 also shifts w1 left by the requested amount as well and a zero fill input fills the empty locations in w1 with zeroes.

| | |
|---|---|
| bits = ( w0 >> ( 32 − req)); | // >> copies req bits from w0 MSBs to LSBs of ‘bits’ |

| | |
|---|---|
| w0 = ( w0 << req )\|( w1 >> ( 32 − req )); | // “\|” is bitwise OR, << is left shift of w0 |

| | |
|---|---|
| w1 = ( w1 << req ); | //left shift of w1 525. |

Note that register Dbits_to_go 630 records the number of valid bits left in temp buffer w1 while, and although, Dbuffer 510 is maintained full and valid at all times. Register Dbits_to_go 630 is coupled via a subtractor 625 and Mux 635 to update a register rem 640 with Dbits_to_go minus requested bits “req”. The contents of register rem 640 are fed into register 630 to become the new Dbits_to_go value.

rem=*Dbits_to_go-req;

If the value in register rem 640 is such that rem <=0, (complement of rem>0 output in FIG. 7B) then this means more bits are requested than were left in temp register w1 (525) and that though some valid bits are still present, register w1 has under-run and needs updating. This also means register w0 (515) is to be updated by the number of bits recorded in the register Avail 645 as these are the bits that were not available due to the underrun. In FIG. 7A, a subtractor 642 or other logic records the magnitude of the negative number of bits into register Avail 645.

The event of rem==0 is handled with care and happens when and signifies that the requested number of bits req is exactly equal to the available-bits number entered in register Dbits_to_go 630. In this case, temp register w0 (515) now has a full 32-bits and operations leave register w0 unmodified. However, register contents of register Wnext (535) are used to refill register wl (525). Update of register w0 (515) is guarded because shift by 32 has a modulo behavior on PC architectures.

| | |
|---|---|
| if ( rem <= 0) | //to Mux 635 selector |

{

Speculatively load Wnext 535 with the next word from Dcodestrm buffer 565.

Wnext = Dcodestrm[*offset];

| | |
|---|---|
| *offset = (*offset + 1); | //Incrementer 665 increments Offset register 368. |

| | |
|---|---|
| if (*offset > Stream_Buf_Words_SZ) | //Comparator 660 and register 670 |

```
  {
*offset = 0;
  }
```

| | |
|---|---|
| avail = −rem; | // Subtracter 642, Avail 645 is nr. underrun 0-bits in w0 |
| LSBs. | |
| w1 = Wnext; | //Replenishes w1 525 from Wnext 535 |
| if (avail) | //If Avail_reg 645 >0, underrun in w0 LBSs is |
| { | //replenished from MSBs of w1 using |
| w0 \|= ( w1 >> ( 32 − avail )); | // subtractor 650 and transfer controlled by Avail value. |

}

| | |
|---|---|
| w1 = ( w1 << avail ); | //Left shift of w1, causes no change in underrun Avail=0. |

| | |
|---|---|
| rem = 32 − avail; | // Subtractor 650 via mux 635. |
| | //Operation updates rem 640 that tells number of remaining bits in w1. |

| | |
|---|---|
| } | //end of ‘if(rem<= 0)’ above |

Next, read the following one-bit into Dbits_1 register 550 to update Dvalue correctly if it is equally-probable decode mode DEC_EQ_PROB. This read into Dbits_1 is a leftmost 1-bit look ahead from w0 to handle the case of equi-probable decoding. Doing this speculative lookahead of 1-bit obviates executing a get_bits operation during equi-probable decode.

*Dbits_1=(w0>>31); // Register 550 reads one MSB from w0 515.

Write out the updated Dbuffer, Dbuffer_next, and Dbits_to_go values before exiting.

| | |
|---|---|
| *Dbuffer = w0; | //Transfer circuit 518 clocks w0 parallel into Dbuffer 510 |
| *Dbuffer next = w1; | // Transfer circuit 528 clocks w1 parallel into Dbuffer_next 520 |
| *Dbits_to_go = rem; | |
| return(bits); | //Bits register 325. |
| } | |

FIGS. 8A and 8B depict complementing process modes for the TI_Get_bits circuit of FIG. 7B. In FIG. 7B, the bit processing circuitry has instruction register 215 that operates as a configuration register or instruction register to hold a request value Req electronically representing a number of bits to extract from data. Control circuitry in FIG. 7B fills first and second data registers 510, 520 and/or W0 515, W1 525 with bits from a source of data. In other words, the control circuitry is operable beforehand to provide the first and second data registers with bits from the source of data and initialize the remaining bits register D_bits_to_go 630 to a value representing the number of bits provided to the second data register from the source of data. The data is held in first data register Dbuffer 510 or W0 515, which has a first width, and in a second data register Dbuffer_next 520 or W1 525 having a second width. The control circuit initializes remaining bits register D_bits_to_go 630, for instance, to a value representing the second width, that of W1 525. Data register W1 525 is coupled to data register W0 515. The data code stream buffer and register Wnext 535 act as a source of data coupled to at least second data register W1 525. Bits_reg 325 acts as an output register for the extracted bits.

Remaining bits register D_bits_to_go 630 and its corresponding interim calculation register Rem 640 are each operated to hold a remaining-number value electronically representing a number for data bits remaining in second data register W1 525. In a step A1 of FIG. 8A, the control circuit in the rest of FIG. 7B responds to the Req value in register 215 to copy bits from first data register W0 515 to the Bits_reg output register 325 equal in number to the request value Req, and then in a step A2 to transfer the rest of the bits in data register W0 515 toward its MSB end regardless of and overwriting the copied bits. In step A3, the control circuit such as by shifter 620 then transfers bits from data register W1 525 to register W0 515 equal in number to the request value Req, and subtractor 625 decrements the remaining-number value in Rem register 640 by the request value Req. Shifter 620 acts as a transfer circuit and a bit-wise OR gate coupled with data registers W0 and W1 to access a specified number of bits from W1 525 and bit-wise-OR the accessed bits with the contents of register W0 515 and store the result of the bit-wise-OR in W0 515 to effectuate step A3. In a step A4, shifter 620 also transfers the rest of the bits in data register W1 525 toward its MSB end regardless of the previously transferred bits therefrom.

In FIGS. 7B and 8B, the bit processing circuit has available-number register Avail reg 645. Recall from above that Subtractor 625 supplies the difference of the remaining-number value in Dbits_to_go 630 less the request value number Req of bits. FIG. 8B shows that operations start with a step B1 same as step A1 to get the Req bits. But going from step B1 to step B2, the bits in register W1 525 are insufficient to fully fill the LSB end of the 32 bit width of register W0 515, so the transfer/bit-wise-OR process leaves a string of zeroes (0) representing the underrun. Correspondingly, in this case when the remaining-number value in Dbits_to_go 630 is less than the request value number Req of bits, their difference is negative in Rem register 640. Accordingly, subtractor 642 uses the value of Rem and enters its magnitude into the available number register Avail reg 645. In a step B3, the control circuit for register W1 525 at the ‘N’ input responds to the value Avail from Avail reg 645 and first fills the register W1 525 from data source portion Wnext 535. Then in a step B4 the circuit transfers a number of bits equal to the available number value Avail from register W1 525 to register W0 515. In a step B5, subtractor 650 enters in Rem 640 a remaining number value (32-Avail) equal to the width of W1 525 less the Avail value from Avail reg 645, and shifter 620 also transfers the rest of the bits in data register W1 525 toward its MSB end regardless of the previously transferred bits therefrom.

Upon completing the operations of FIGS. 8A and 8B as the case may be, the applicable remaining number value in Rem 640 is used to update Dbits_to_go 640 at step B5. The operations of FIGS. 8A and 8B are executed repeatedly in response to repeated assertion of the Get_bits Instruction with a request value Req in instruction register 215. Instruction decoder 605 responds to the Get_bits instruction in Instruction register 215 to activate operation of the control logic in FIGS. 7A/7B as described herein. In this way, register W0 515 is always full across its entire width upon completion of each operational cycle, and the number of data bits in W1 525 as represented by Dbits_to_go 640 is some portion (occasionally all) of the second bits-width of register W1 525. Since register W0 515 is full across its entire width, software issuing a subsequent Get_bits Instruction execution by TI_Get_bits hardware is always able to request any number of bits Req from one bit up to the width of register W0 515, or of Dbuffer that W0 supports. In embodiments in which the data is streaming through a stream buffer as data source and through Dbuffer_next 520 and Dbuffer 510, the TI_Get_bits circuitry efficiently is used to remove a requested number of bits Req and the bit stream continues, except with those bits removed.

### Put Bits

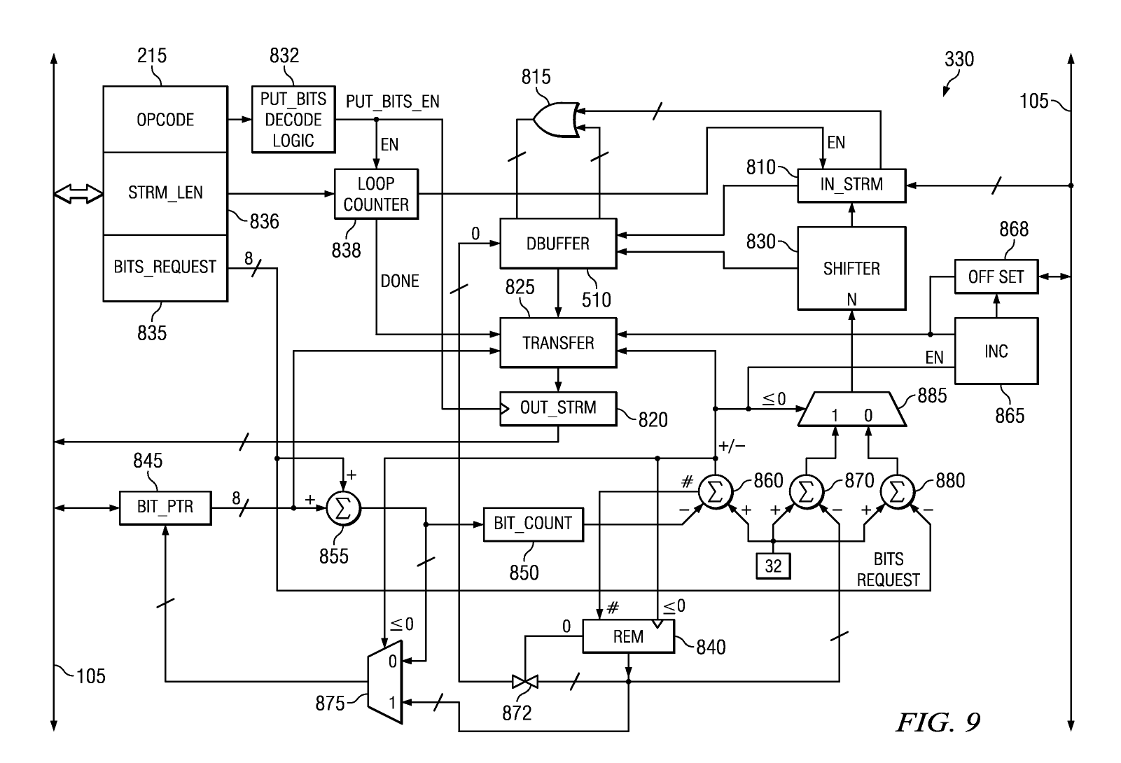

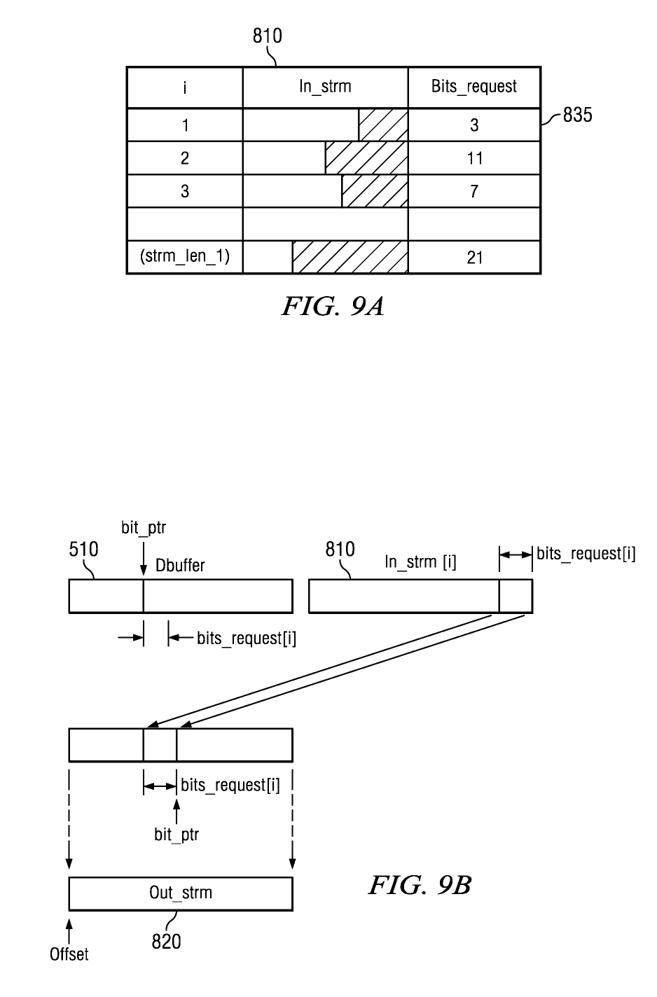

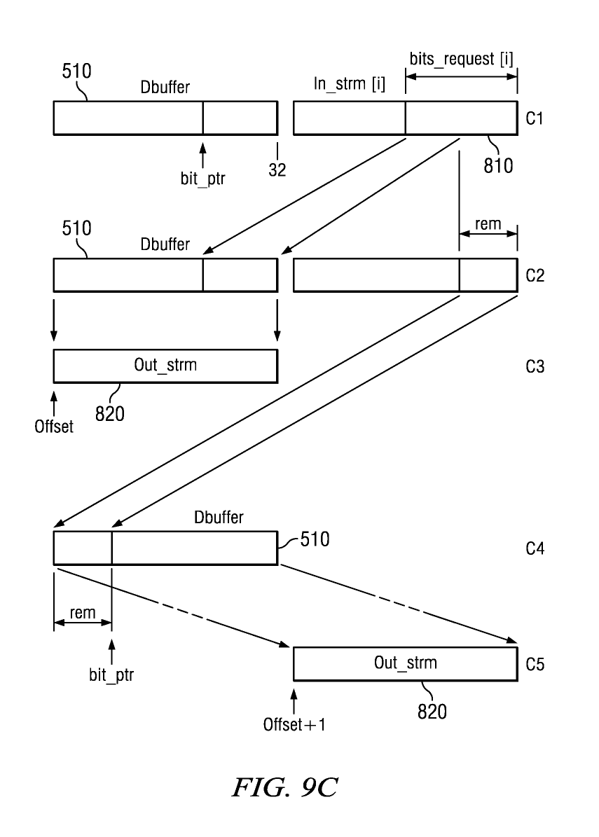

The Put_bits(N) Instruction and its hardware in FIGS. 4 and 9 operate as a hardware function to put bits into 32-bit buffer Dbuffer 510. Put_bits(N) hardware is a 2-stage pipeline, but capable of accepting a new request every cycle, allowing Put_bits to work at the rate of 1 request/cycle.

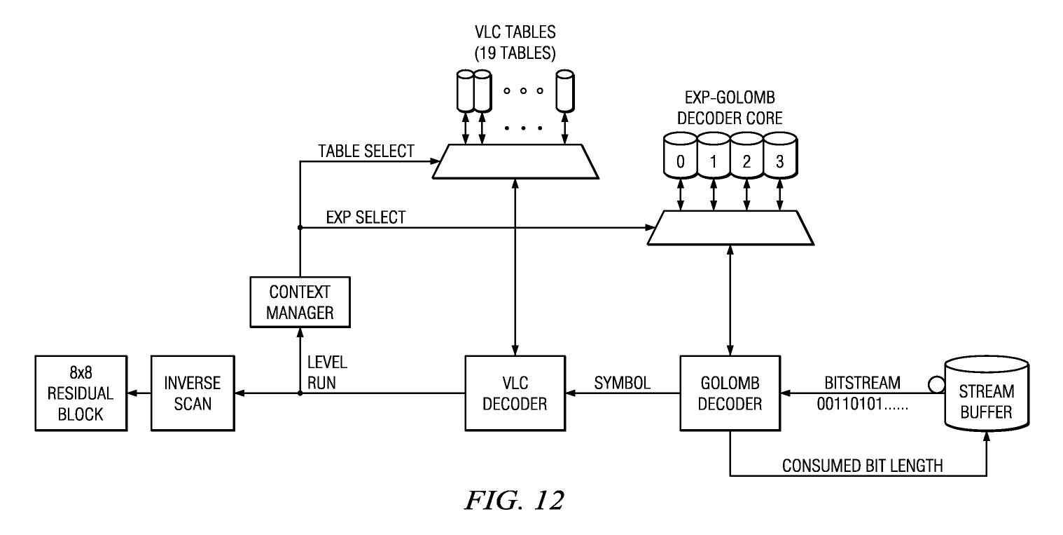

Compare with a conceptual PutBit( ) procedure in H.264, section 9.3.4.3 and its FIG. 12-9, said there to provide carry over control by using a function WriteBits(B, N) to write N bits with value B to the bitstream and advance the bitstream pointer by N bits. Some background on a kind of put bits is provided in U.S. patent application Publication “Video Coding” 20080317134, dated Dec. 25, 2008 (TI-36672), which is incorporated herein by reference in its entirety.

By contrast, here a hardware embodiment called TI_Put_bits delivers H.264 support but by its own distinct, remarkably efficient and versatile circuit and process. C code for defining the TI_Put_bits hardware follows, and is annotated in the listing and illustrated by blocks in FIG. 9. Operations use a register circuit in FIG. 9A such as a buffer having index i-accessible areas In_strm[i] 810 and Bits_request[i] 835. A working buffer Dbuffer 510 is coupled to In_strm[i] 810 and supports the FIG. 9 TI_Put_bits hardware operations of FIGS. 9B and 9C, which operations supply an output bit stream to output register Out_strm 820.

Here, the TI_Put_bits hardware writes bit fields of requested sizes to an array in a packed format. Given a real estate efficient data buffer Dbuffer size (e.g., 32 bits), the FIG. 9 circuitry adeptly handles not only cases within the size confines of Dbuffer but also cases in which Dbuffer could spill over. The C code and its comments are provided to describe the hardware as well as to relate the hardware operations to the process embodiments in FIGS. 9B and 9C.

void TI_Put_Bits

(

| | |
|---|---|
| uint8 *bits_request, | //835 number of insertion bits requested |
| int strm_len, | // 836 stream length (looping number) |
| uint32 *in_strm, | //810 receives bits to input into bit stream |
| uint32 *Dbuffer, | //510 working data buffer for bit insertion |
| uint8 *bit_ptr, | //845 bit pointer, number of valid bits in Dbuffer |
| uint32 *out_strm, | //820 outputs latest stream bits |
| int32 *offset | //868 |

)

{

| | |
|---|---|
| int i; | //838 |
| int bit_count; | //850 |
| int rem; | //840 |

| | |
|---|---|
| for ( i = 0; i < strm_len; i++) | //Counter 838 counts up. |

{

Get a total bit_count and make sure out-request can be met and Dbuffer will not spill over (bit_count>32 indicates spillover).

bit_count=*bit_ptr+bits_request[i]; // Summer 855 sums values in 835, 845.

If bit_count is less than 32, then shift bits from in_strm into Dbuffer and OR with Dbuffer. Update bit_ptr to indicate increased number of valid bits in Dbuffer after the data insertion. See FIGS. 9, 9A and 9B.

| | |
|---|---|
| if (bit_count < 32 ) | //Subtracter 860 sends controls to Mux 885 |

{

//FIG. 9B, Bitwise insertion by OR-gate 815. (‘|’ symbol)

*Dbuffer = *Dbuffer | ( in_strm[i] << ( 32 − bits_request[i] ) >> *bit_ptr );

//transfers bits_request LSBs of In_strm into MSBs
//ofDbuffer.

| | |
|---|---|
| *bit_ptr = *bit_ptr + bits_request[i]; | //Summer 855 feeds back to 845 |

| | |
|---|---|
| | // through Mux 875, and bit_ptr<32. |
| } | |

Otherwise, write out whatever bits can be written out by shifting from in_strm and ORing with Dbuffer, and save current Dbuffer into out_strm[ ], update the Offset for out_strm[ ] buffer and write out remaining bits into Dbuffer. If remaining bits rem is 0, clear out Dbuffer. See FIGS. 9 and 9C. FIG. 9C step C1 shows the initial state of the registers.

| | |
|---|---|
| | //else: Bit count is at least 32. |
| else | //Transfer circuit 825 enable goes active. |
| { | //FIG. 9C step C1, Bitwise insertion by OR-gate 815. (‘\|’) |
| | //But, Rem bits spill over, not stored yet. |

| *Dbuffer = *Dbuffer \| ( in_strm[i] << ( 32 − bits_request[i] ) >> *bit_ptr ); | |
|---|---|
| out_strm[*offset] = *Dbuffer; | //Offset 868, transfer 825 from 510 to 820. |

//FIG. 9C step C2 to C3.

| | |
|---|---|
| *offset = *offset + 1; | //Offset 868 and incrementer 865, prep for C5. |

| | |
|---|---|
| rem = bit_count − 32; | //Subtractor 860 magnitude to Rem 840 |
| if(rem) | //if bit_count>32 |

| { | //FIG. 9C step C2 to C4 stores remaining |
|---|---|
| | //(Rem) bits from In_strm to Dbuffer. |

| | |
|---|---|
| *Dbuffer = (in_strm[i] << ( 32 − rem )); | //Subtractor 870, shifter 830 |

}

| | |
|---|---|
| else | //bit_count=32 |

{

| | |
|---|---|
| *Dbuffer = 0; | //Gate 872, rem=0 to Dbuffer 510 |

}

Now, bit_ptr is updated to show that rem number of bits are valid in Dbuffer.

| | |
|---|---|
| *bit_ptr = rem; | //rem 840 through Mux 875 to 845 |

| | |
|---|---|
| } | //end ‘else’ |
| #endif | |

| | |
|---|---|
| } | //end ‘for’ loop |

Once finished writing out all the requested bits, write out the remaining (residual) bits in Dbuffer out to the current offset of out_strm

| | |
|---|---|
| if(*bit_ptr) | //Enable transfer circuit 825 |
| { | //Offset 868 coupled to transfer ckt 825 |

| | //FIG. 9C, step C5: |
|---|---|
| out_strm[*offset] = | //Transfer Dbuffer 510 to out_strm 820 |
| *Dbuffer; | |

}
return;

}
SHOW BITS

An embodiment called TI_Show_bits provides a further efficient and remarkable circuit structure and process herein. Compare with H.264, Section 7.2 discussion of a syntactical function next_bits(n), conceptually used as a syntactical function to provide the next n bits in the bitstream for comparison purposes, without advancing the bitstream pointer. If fewer than n bits remain when reading, a value 0x0 is returned, consistent with H.264, Section 7.2 and Annex B section B.1.1.

Some background mentioning a kind of show_bits function is provided in U.S. patent application Publication “Video error detection, recovery, and concealment” 20060013318, dated Jan. 19, 2006 (TI-38649), which is incorporated herein by reference in its entirety.

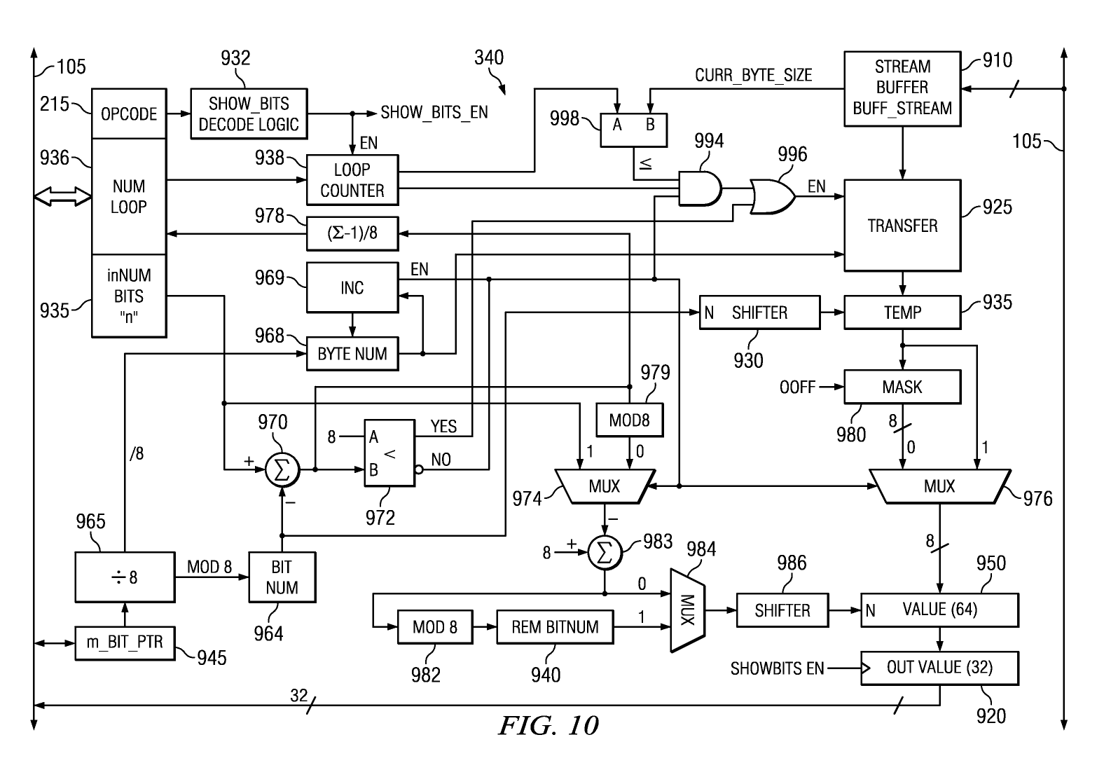

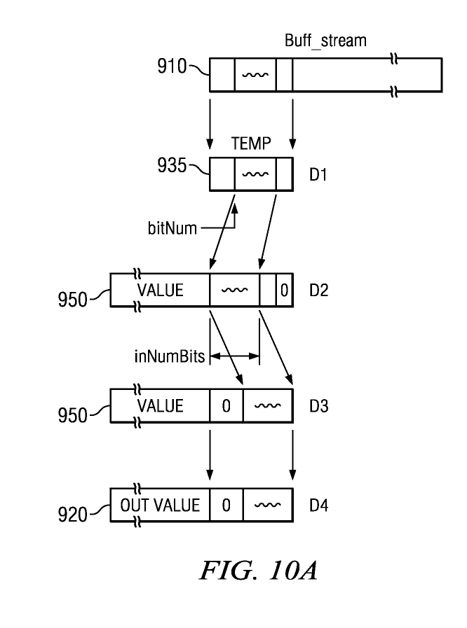

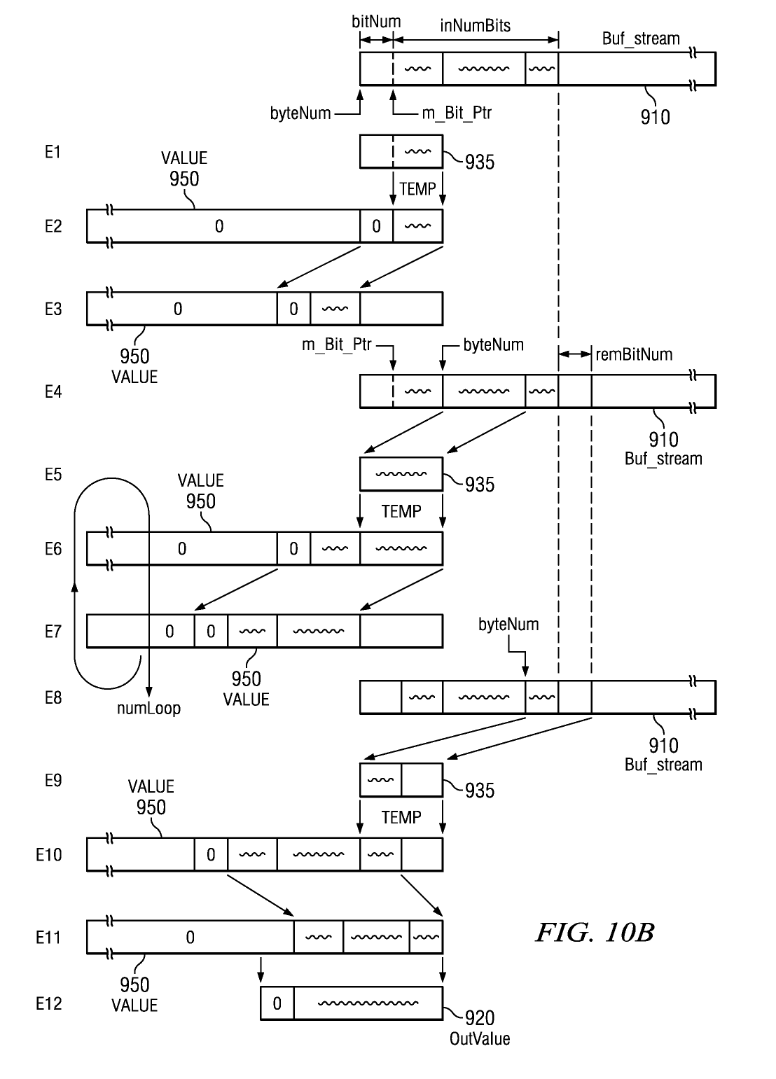

The TI_Show_bits circuit embodiments taught herein can deliver performance according to remarkable and efficient structure to support such operations. C code for defining the TI_Show_bits hardware is annotated with numerals corresponding to enumerated illustrative blocks in FIG. 10. Operations use a stream buffer Buf_stream 910 having a pointer m_Bit_Ptr from which a byte pointer byteNum and bit pointer bitNum in that byte are derived. A temporary register Temp coupled to Buf_stream 910 acts as a small data working buffer and cooperates with a wider register named Value that both acts as a wider data working buffer and intermediate output register to support the FIG. 10 TI_Show_bits hardware operations of FIGS. 10A and 10B, which operations supply an output bit stream to a second output register OutValue 920.

Here, the TI_Show_bits hardware writes bit fields of requested sizes to OutValue in a packed format. Given a real estate efficient Temp register of limited size (e.g., a byte or 8 bits), the FIG. 10 circuitry adeptly handles not only cases within the size confines of the Temp register but also cases beyond them. The C code and its comments are provided to define hardware, a form of which is shown in FIG. 10, as well as to relate the hardware operations to the process embodiments in FIG. 10A (steps D1-D4) and FIG. 10B (steps E1-E12).

C code for TI_Show_bits:

unsigned int TI_Show_Bits
(

| | | |
|---|---|---|
| Buff_Stream | *buff_stream, | //Stream Buffer 910 |

| | | |
|---|---|---|
| U32 | inNumBits, | //915, Input Number n of bits from bus 105 |
| U32 | *outvalue | //920, Output a 32 bit value to show. |

)
{

| | | |
|---|---|---|
| unsigned int | m BitPtr; | //Bit Pointer 945 into Stream Buffer 910 |

| | | |
|---|---|---|
| unsigned int | bitNum; | //964, Bit Pointer mod 8 from divider 965 |
| unsigned int | byteNum; | //968, Bit Pointer div.-by-8 trunc quotient 965 |
| unsigned int | numLoop; | //936, num of bytes to transfer frm Buffer 910 |
| unsigned int | i; | //Current value in loop counter 938 |

| | | |
|---|---|---|
| unsigned char | temp; | //Temporary register 935 |

| | | |
|---|---|---|
| unsigned int | remBitNum; | //940 |

| | | |
|---|---|---|
| U64 | value; | //64 bit concatenating register |

Make sure that incoming request is >0 and <32. Since the type of in NumBits is unsigned, it has to be greater than 0, but nonetheless screen it:

assert(inNumBits > 0);
assert(inNumBits <= 32);

Initialize the returned value to 0, and compute the bitNum and byteNum.

value=0;

Read initial bit pointer from io_struct passed.

| | |
|---|---|
| m_BitPtr = buff_stream−>m_BitPtr; | //945, 910 |

| | |
|---|---|
| bitNum = m_BitPtr % 8; | //964, Bit Pointer 945 mod 8 from divide 965 |

//in binary, just use 3 LSB lines.

| | |
|---|---|
| byteNum = m_BitPtr / 8; | //968, Bit Pointer 945 div. by 8 in |
| | // divider 965, just all lines except 3 LSB lines. |

Return that the request could not be met, so return 0, where app expects in NumBits.

| | |
|---|---|
| if(byteNum > buff_stream−>curr_byte_size) | //Comparator 998 |
| return 0; | |

If the current bitNum plus the request for in NumBits is less than 8, then read in the byte, and prepare the entire request from this byte.

| if(bitNum + inNumBits < 8) | //Summer 970 and |
|---|---|
| | //Comparator 972 |
| | //operate muxes 974, |
| | 976, 984 |

{

| | |
|---|---|
| Read in one byte from the buffer. | |
| temp = buff_stream−>buff[byteNum]; | //Transfer 925 from 910 to |

935
//FIG. 10A step D1: byte
goes to Temp.

Shift away (eliminate from show process in FIG. 10A step D2) the extraneous left-bits that have already been read, keep the remainder as a byte by ANDing with 0xFF, and deliver to Value 950. Consider an example: Suppose m_BitPtr is 43, then bitNum is 3, byteNum is 5. So shift away previous 3 bits.

| | |
|---|---|
| value = (temp << bitNum) & | //Temp 935, Shifter 930, Mask 980, |
| 0xFF; | |
| | //through Mux 976 to Value 950 |

Suppose in Bits is 3. These 3 bits are now left-justified, so right justify them in FIG. 10A step D3 by shifting right by 8 minus in NumBits. Depending on the use to which the left-justified bits might be put, some embodiments use step D3 to obtain right justified bits, or instead omit step D3 to deliver left-justified bits.

| | |
|---|---|
| value >>= | //915 through Mux 974 to Subtracter 983 |
| (8 − inNumBits); | |
| | //through Mux 984 to control Shifter 986 of |
| | // Value register 950 |

Store out the request in step D4, and return the number of bits requested in in NumBits.

*outValue=(U32)value; //Value 950 to Out value 920

Bit_ptr is not incremented in this Show_bits function.

return inNumBits;

| | |
|---|---|
| } | |
| else | //One or more additional bytes of buff stream |
| | // are involved, so operate muxes 974, 976, 984 |
| { | //See FIG. 10B. |

Read in one byte from the buffer in FIG. 10B, step E1.

temp=buff_stream->buff[byteNum]; //Transfer 925 from 910 to 935

Increment the current byteNum where the read is from for the byte that was just read.

byteNum++; //Incrementer 969, ByteNum 968

Mask away the bits which have already been read. Read as many bytes as required to meet the request. For example, if bitPtr is 3, upper 3 bits are set to 0. See step E2.

value=temp & buff_stream->m_tabMask[bitNum]; //Transfer 925, Temp 935
//& is bitwise

Find out how many additional bytes are needed to accomplish steps E3-E10 of FIG. 10B. Service requests from in NumBits of 1 to 15 bits with one more read. (“/8” signifies quotient, not considering remainder. The “−1” in the C code basically causes a round-down in case the sum of bitNum+inNumBits is an integral multiple of 8.)

| | |
|---|---|
| numLoop = ((bitNum + | //NumLoop 936 from arithm. ckt 978 |
| inNumBits − 1)/8); | |
| | //from Summer 970 from 964, 915 |

Iterate for as many bytes as needed, and read while Offset is less than current size of buffer.

for (i = 0; i < numLoop; i++) //Counter 938 upcounts to one less than NumLoop 936.

{

| | |
|---|---|
| if(byteNum < buff_stream−>curr_byte_size) | //Comparator 998 qualfies AND994 |
| { | //See FIG. 10B step E5 (and E9) |

| temp = buff_stream−>buff[byteNum]; | //AND 994 through OR 996 |
|---|---|
| | //enables Transfer 925. |
| byteNum++; | //Incrementer 969, ByteNum 968 |

// See FIG. 10B step E4 (and E8).

| } | |
|---|---|
| else | //Comparator 998 disqualfies AND994 |

{

| | |
|---|---|
| return (i * 8); | //Looping to show inNumBits has exhausted buff_stream. |

| | //Process reports number of bits obtained, and returns. |
|---|---|
| } | |
| value <<= 8; | //Shifter 986 shifts Value 950 by 8 bits, step E3 (and E7) |
| value \|= temp; | //Temp 935 byte through 976 goes |

// into empty byte of Value 950. Step E6 (and E10).

| | |
|---|---|
| } | //end of ‘for’ loop |

First keep the remBitNum 940 modulo 8 from summer 983 via modulo circuit 982, and then apply this remBitNum via mux 984 as the shift amount for shifter 986 to return the value in Value register 950 right justified. The variable remBitNum is the shift amount to apply.

| | |
|---|---|
| remBitNum = 8 − (bitNum + | //Summer 970, mod8 979, Mux 974, |

| | |
|---|---|
| inNumBits) % 8; | |
| | // to Summer 983 to remBitNum 940 |

| | |
|---|---|
| remBitNum %= 8; | //mod 8 circuit 982 outputs 3 LSBs |

| | |
|---|---|
| value >>= remBitNum; | //Step E11 right-shifts Value 950 |
| | //to right-justify the Show bits. |

Store value, and return the decoded in NumBits.

| | |
|---|---|
| *outvalue = (U32)value; | //Step E12 transfers Value |

950 to Out value 920.

return inNumBits;

| | |
|---|---|
| } | //end of ‘else’ |

}

The above hardware-defining code thus provides an extensive hardware code description illustrated by FIGS. 4 and 7A-10. Numerous circuit embodiments can be provided and merged together and optimized to economize circuitry as indicated by some parallelism of enumeration. In some embodiments, the data buffer Dbuffer, transfer circuit and temporary or working buffer are grouped into one Stream Data Unit 500 as in FIG. 3, and three or more respective Stage i Stream Decoders include circuits to execute corresponding Instructions i, such as Get_bits, Put_bits, and Show_bits that share the Stream Data Unit 500. In some other embodiments even more of the various registers, shifter, transfer circuit, counter, summer, subtractors, and muxes are re-used in one such Stage Stream Decoder to execute the different Instructions Get_bits, Put_bits, and Show_bits. In still other embodiments a Get_Show_bits hardware not only provides a pointer m_Bit_Ptr but also responds to a combined Instruction to extract specified bits having width in NumBits as in FIG. 10B, and advances the pointer and eliminates the requested bits from the data stream while separately delivering them to Bits_Reg 325.

The TI_Put_bits circuit and TI_Show_bits circuit each include control logic conditionally operable in response to a data width request register such as Bits_Request 835 or in Numbits 935 to detect a first condition when a data unit size of data in a data working buffer is exceeded by a value in the data width request register and then to activate repeated control of a transfer circuit, which is selectively operable to transfer data from the data working buffer to an output register, for plural transfer operations. The control logic is otherwise operable on a second condition representing that the data unit size is not exceeded by that data width request value, to thereupon execute a data processing operation on the data working buffer. After detection of either of said conditions, the control logic issues a subsequent control for a further transfer circuit operation. A data processor 100 with a storage circuit 140 is coupled to bus 105 and operable to access the input register and to configure the data width request register and activate the control logic.

In the FIG. 9 TI_Put_bits circuit, the control logic inserts bits from an input register into a data stream mediated by the data working buffer and operates the transfer circuit to transfer the data stream from the data working buffer to an output register. Also, the data working buffer Dbuffer in FIG. 9 has a limited size and the first condition also represents when the limited size of Dbuffer would be exceeded and the second condition represents that the limited size of Dbuffer is sufficient.

In the FIG. 10 TI_Show_bits circuit, the data working buffer has a limited size (e.g., a 32 bit word) of more than one byte and the data unit size is one byte. The data processing operation includes a bit operation on bits in a byte. The control logic circuit thereby effectuates a show bits instruction.

In FIGS. 7B, 9, and 10, instruction register 215 is coupled to bus 105, and a respective instruction decoder 605, 832, or 932 responds to a Get_bits, Put_bits, or Show_bits instruction in instruction register 215 to selectively activate operation of the corresponding control logic.

In FIGS. 9 and 10, for instance, a pointer register Bit_Ptr 845 or m_Bit_Ptr 945 is employed. The control logic detects a pointer register condition to disqualify the subsequent control, and the further transfer circuit operation mentioned above is selectively obviated. Depending on the instruction involved, a pointer update circuit is coupled to the pointer register and conditionally activates a pointer update (or not) depending on which instruction is in said instruction register. A loop count register and circuitry, such as Strm_Len 836 and Loop Counter 838, or NumLoop 936 and Loop Counter 938, is conditionally activated for repeated operation. The respective control logic is operable to terminate the repeated control after completion of a number of repeated control operations related to a value in the loop count register, such as by upcounting to that value in one kind of circuit or downcounting from that value in another kind of circuit.

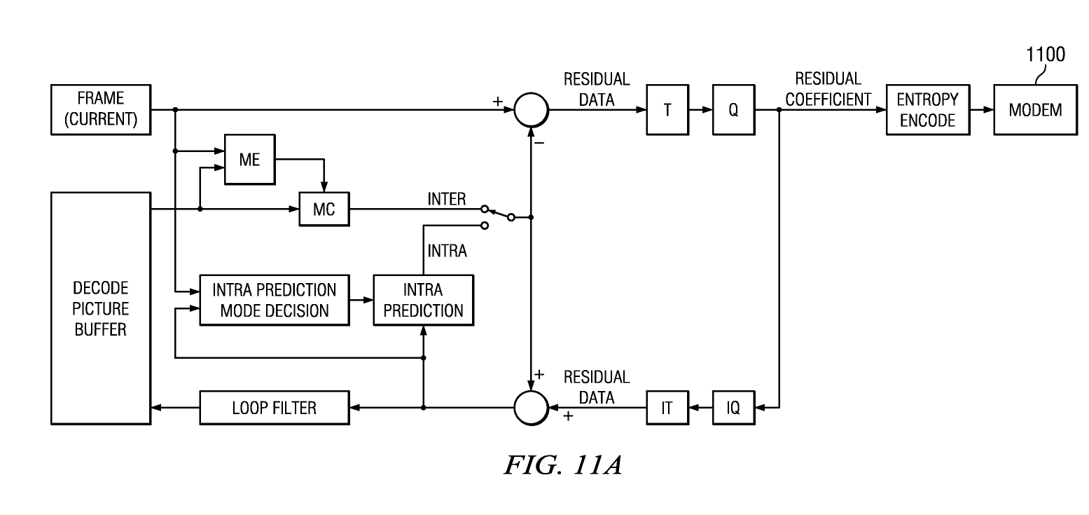

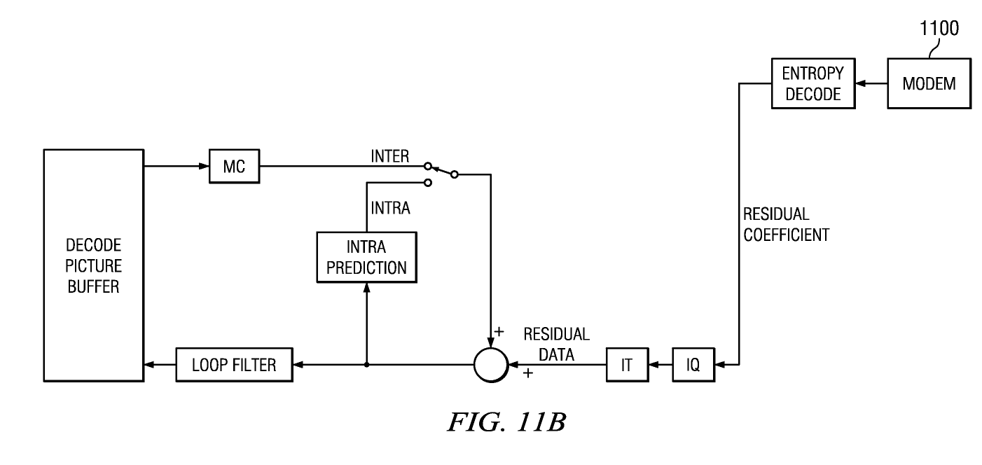

Turning to FIG. 11A, a video encoder has Motion Estimation ME, Motion Compensation MC, intra prediction, spatial transform T, quantization Q and loop-filter such as for H.264 and AVS. As shown in the various Figures herein, the video encoder is remarkably improved for performance and economy. An Entropy encoder block is improved remarkably as taught herein and fed by residual coefficient output data from quantization Q. The entropy encoder block reads the residual coefficient into a payload RBSP and provides start code and syntax elements of each NAL unit, and converts them into an output bit stream. During encoding, exp-golomb code and 2D-CAVLC (context adaptive VLC) or CABAC are applied with substantial performance enhancement, latency reduction, and improved real-estate and power economies as described herein. Feedback is provided by blocks for motion compensation MC, Intra Prediction, inverse transform IT, inverse quantization IQ and loop filter.

In FIG. 11A, a current Frame is fed from a Frame buffer to a summing first input of an upper summer. The upper summer has a subtractive second input that is coupled to the selector of a switch that selects between predictions for Inter and Intra Macroblocks. The upper summer subtracts the applicable prediction from the current Frame to produce Residual Data (differential data) as its output. The Residual Data is compressible to a greater extent than non-differential data. The Residual Data is supplied to the Transform T, such as a discrete cosine transform (DCT), and then sent to Quantization Q. Quantization Q delivers quantized Residual Coefficients in macroblocks having 8×8 blocks, for instance, for processing by the Entropy Encode block and ultimately modulating for transmission by a modem 1100 of FIG. 14. Encode in some video standards also has an order unit that orders macroblocks in other than raster scan order.

Further in FIG. 11A, the Residual Coefficients are fed back through inverse quantization IQ and inverse transform IT to supply reconstructed Residual Data to a summing first input of a lower summer. The lower summer has a summing second input that is coupled to and fed by the selector switch that selects between the predictions for Inter and Intra Macroblocks. The lower summer adds the applicable prediction to the reconstructed Residual Data to produce a lower summer output. The lower summer output is 1) fed to a Loop Filter and 2) also feeds an Intra Prediction block to provide the switch with the Intra prediction, and 3) further feeds a first input of a block for Intra Prediction Mode Decision. Intra prediction basically predicts a macroblock of the current frame from another macroblock of that frame. The current Frame is fed to a second input of the block for Intra Prediction Mode Decision, which in turn delivers a mode decision to the Intra Prediction block.

The Loop Filter, also called a Deblock filter, smoothes artifacts created by the block and macroblock nature of the encoding process. The H.264 standard has a detailed decision matrix and corresponding filter operations for this Deblock filter process. The result is a reconstructed frame that becomes a next reference frame, and so on. The Loop Filter is coupled at its output to write into and store data in a Decoded Picture Buffer. Data is read from the Decoded Picture Buffer into two blocks designated ME (Motion Estimation) and MC (Motion Compensation). The current Frame is fed to motion estimation ME at a second input thereof, and the ME block supplies a motion estimation output to a second input of block MC. The block MC outputs motion compensation data to the Inter input of the already-mentioned switch. In this way, the image encoder is implemented in hardware, or executed in hardware and software in the IVA processing block IVA and/or video codec block 3520.4 of FIG. 14, and efficiently compresses image Frames and entropy encodes the resulting Residual Coefficients as taught herein.

In FIG. 11B, a video decoder is related to part of FIG. 11A and, compared to FIG. 11A, FIG. 11B substitutes for Entropy Encode a remarkable block Entropy Decode instead and as described in various Figures herein. FIG. 11B uses the feedback blocks, and omits the blocks Frame (current) and associated block Intra Prediction Mode Decision, and further omits Motion Estimation ME, upper summer, Transform T and Quantization Q.

The video decoder embodiment of FIGS. 11B and 12 has its Entropy decoder block remarkably improved as in the other Figures for performance and economy. A modem 1100 of FIG. 14 receives a telecommunications signal and demodulates it into a bit stream. The entropy decoder block efficiently and swiftly processes the incoming bit stream and detects the incoming start code and reads the syntax elements of each NAL unit, and further reads the payload RBSP and converts it into residual coefficients and some information for syntax of the Macroblock header such as motion vector and Macroblock type. An exp-golomb decoder and 2D-CAVLD or CABAC decode are applied in the entropy decoder block. In accordance with some video standards, a reorder unit in the decoder may be provided to assemble macroblocks in raster scan order reversing any reordering that may have been introduced by an encoder-based reorder unit, if any be included in the encoder.

In FIG. 11B, the macroblocks of residual coefficients are inverse quantized in block IQ, and an inverse of the transform T is applied by block IT, such as an inverse discrete cosine transform (IDCT), thereby supplying the residual data as output. The residual data is applied to a FIG. 11B summer (lower summer of FIG. 11A). Summer output is fed to an Intra Prediction block and also via the Loop Filter to a Decoded Picture Buffer. The Loop Filter, also called a Deblock filter, smoothes artifacts created by the block and macroblock nature of the encoding process. Motion Compensation block MC reads the Decoded Picture Buffer and provides output to the Inter input of a switch for selecting Inter or Intra. Intra Prediction block provides output to the Intra input of that switch. The selected Inter or Intra output is fed from the switch to a second summing input of the summer. In this way, an image frame is constituted by summing the Inter or Intra data plus the Residual Data. The result is a decoded or reconstructed frame for image display, and the decoded frame also becomes a next reference frame for motion compensation.

In FIG. 12, VLC tables are implemented into encoder H/W storage in some embodiments. CAVLC (context adaptive variable length coding) of some video standards have VLC tables, e.g., 7 tables for luma Intra Macroblock, 7 tables for luma Inter Macroblock and 5 tables for chroma Macroblock. In FIG. 12, the decoder core has four types of Exp-Golomb decoder, the VLC tables, VLC decoder and a Context Manager. Firstly, the Exp-Golomb decoder reads the bit stream payload and obtains symbol and consumed bit length. The bit length is sent to stream buffer and defines a pointer of the stream buffer for decoding a next symbol. The obtained symbol is sent to VLC decoder. The VLC decoder decodes the symbol and obtains Level (non-zero residual coefficient value) and Run (how many zeroes between two consecutive instances of Level) by applying the VLC table selected by context manager. The obtained Level and Run are sent to Inverse Scan and Context Manager. Inverse Scan outputs coefficients to fill up a 2D Residual Block with residual coefficients having Level values positioned according to the Run information. In FIG. 12, the macroblocks of residual coefficients, in e.g. 8×8 blocks, are stored in a storage situated at the point in the encoder block diagram of FIG. 11B labeled Residual Coefficient. In FIG. 12, the Context Manager updates the selection of VLC table and Exp-Golomb decoder to be applied to next coefficient. Decoding of residual coefficients is accomplished and improved as taught herein.

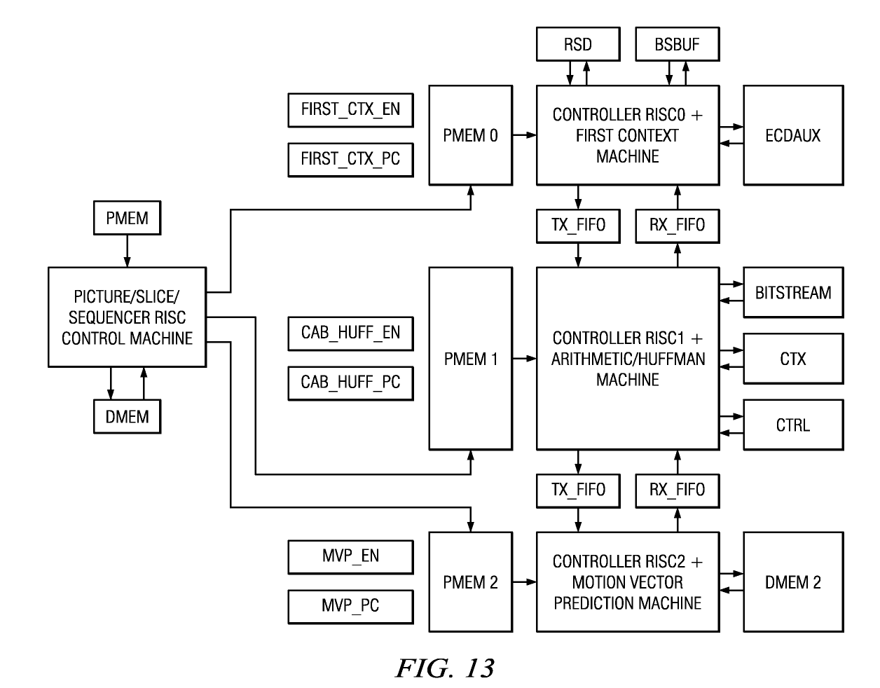

FIG. 13 shows a block diagram of an embodiment of an Entropy decoder operating as described herein. The Picture/Slice/Sequencer Control engine performs the functions of the Slice Processor 100 of FIGS. 1 and 2 hereinabove. In some embodiments, the remaining blocks are hardware units as in FIGS. 3-10B, and in other embodiments programmable blocks as in FIG. 13 are employed.

In FIG. 13 a high level architecture view is depicted for a programmable ECD (Entropy Coder and Decoder) engine, designated a PECD. The PECD engine includes a Master Controller Engine (MCE) associated with three programmable accelerators RISC0, RISC1, RISC2. The Master Controller Engine is coupled to a program memory PMEM and a data memory DMEM and operates as a Picture/Slice/Sequencer Control engine. The MCE has, e.g., a RISC engine with instructions to execute picture, slice and sequence header processing, and to swiftly and efficiently execute a bounding box algorithm. The bounding box algorithm aggregates individual small requests based on the motion vectors returned by the accelerator RISC2 into a larger single request where possible to maximize the efficiency of the memory DMEM, such as DDR DRAM. In addition, the MCE efficiently submits DMA requests to fetch data from DDR DRAM to the memories of the programmable accelerators including data memory DMEM2, program memories PMEM0, PMEM1, PMEM2 and control memory CTRL. MCE suitably uses a DMA implementation compatible with the system with which MCE operates. A system bus for the PECD is present but omitted from FIG. 13 for conciseness and clarity of illustration.

To accelerate bit-stream related processing, the PECD engine includes accelerator RISC1 operating as a Arithmetic/Huffman machine that has a built-in bit-stream unit BITSTRM for operation to perform single-cycle get_bits( ) put_bits( ) and show_bits( ) bit-processing primitives as in FIG. 4 in the video/image processing. The bit-stream unit BITSTRM is suitably programmed to hunt for start codes to detect NAL unit and packet boundaries over a pre-defined length of N bytes, setting the location between two 32-bit start codes without the intervention of the MCE. The MCE can poll accelerator RISC1 with the bit-stream unit BITSTRM for completion, suspend the hunt for start codes, or be interrupted by the bit-stream unit when a valid packet has been located. In this form of execution, the bit-stream unit BITSTRM runs in an autonomous fashion to the MCE processor pipeline.

The MCE loads program code for each of the three programmable accelerators RISC0, RISC1, RISC2 into their associated program memories PMEM0, PMEM1, PMEM2 and control memory CTRL, programs a respective starting PC (program counter) address into each respective program counter FIRST_CTX_PC, CAB_HUFF_PC, MVP_PC for each accelerator RISC0, RISC1, RISC2, and provides respective enables FIRST_CTX_EN, CAB_HUFF_EN, MVP_EN to initiate execution of instructions by each of those accelerator machines. The MCE engine can be detecting the next NAL unit and perform slice header and slice parsing while the first context machine RISC0, arithmetic Huffman machine RISC1 and motion vector prediction machine RISC2 are working on the macroblock layer.

Accelerator RISC0 operates as a controller and context machine for executing context supporting operations for CABAC (Context Adaptive Binary Arithmetic). Accelerator RISC1 is supported by accelerator RISC0 and provides a binary arithmetic encoding and decoding engine that takes a binarized video bit stream and compresses or decompresses it using arithmetic coding. The least probable and most probable symbol (LPS and MPS) respectively are assigned starting probabilities and constitute ‘contexts’ and are adapted continuously based on whether a zero or a one was encountered in the previous cycle. RISC 1 bi-directionally communicates with RISC0 by a transmit first-in-first-out circuit TX_FIFO from RISC0 and by a receive RX RISCO FIFO to RISC0. Context Machine RISC0 is also coupled to and supported by circuit blocks designated ECDAUX (ECD auxiliary circuit), bit stream buffer BSBUF, and a residual stream decoder RSD.

CABAC has three main constituents: binarization of the input symbol stream (quantized transformed prediction errors also called residual data) to yield a stream of bins, context modeling (conditional probability that a bin is 0 or 1 depending upon previous bin values), and binary arithmetic coding (recursive interval subdivision with subdivision according to conditional probability). (In H.264, a bin string is an intermediate binary representation of values of syntax elements from the binarization or mapping of the syntax element onto the binary representation.) To limit computational complexity, the conditional probabilities are quantized and the interval subdivisions are repeatedly renormalized to maintain dynamic range. U.S. Pat. No. 7,176,815 is incorporated herein by reference and shows some background and discusses reduced computational complexity for the CABAC of H.264/AVC, in mobile, battery-powered devices and other products.

The accelerator RISC2 determines the positions and motion vectors of moving objects within the picture and returns the motion vectors, see discussion of Motion estimation block ME in FIGS. 11A and 11B. Motion compensation in the MCE is used to remove temporal redundancy between successive images (frames) using the motion vectors. Transform coding is used to remove spatial redundancy within each frame and is suitably supported by RISC1, which also quantizes the transforms of block prediction errors resulting either from block motion compensation or from intra-frame prediction. RISC 1 bi-directionally communicates with RISC2 by a transmit first-in-first-out circuit TX_FIFO to RISC2 and by a receive RX_FIFO from RISC2. The partitioning of various operations among the MCE and accelerators RISC0-3 may vary in different embodiments. Also, the functions described for various blocks in FIG. 13 are applicable in describing the other Figures.

In FIG. 14, an embodiment improved as in the other Figures herein has one or more video codecs implemented in IVA hardware, video codec 3520.4, and/or otherwise appropriately to form more comprehensive system and/or system-on-chip embodiments for larger device and system embodiments. In FIG. 14, a system embodiment 3500 improved as in the other Figures has an MPU subsystem and the IVA subsystem, and DMA (Direct Memory Access) subsystems 3510.i. The MPU subsystem suitably has one or more processors with CPUs such as RISC or CISC processors 2610, and having superscalar processor pipeline(s) with L1 and L2 caches. The IVA subsystem has one or more programmable digital signal processors (DSPs), such as processors having single cycle multiply-accumulates for image processing, video processing, and audio processing. IVA provides multi-standard (H.264, H.263, AVS, MPEG4, WMV9, RealVideo®) encode/decode at D1 (720×480 pixels), and 720p MPEG4 decode, for some examples. A video codec for IVA is improved for high speed and low real-estate impact as described in the other Figures herein. Also integrated are a 2D/3D graphics engine, a Mobile DDR Interface, and numerous integrated peripherals as selected for a particular system solution.

Digital signal processor cores suitable for some embodiments in the IVA block and video codec block may include a Texas Instruments TMS32055x™ series digital signal processor with low power dissipation, and/or TMS320C6000 series and/or TMS320C64x™ series VLIW digital signal processor, and have the circuitry of the FIGS. 1-14 coupled with them as taught herein. For example, a 32-bit eight-way VLIW (Very Long Instruction Word) pipelined processor has a program fetch unit, instruction dispatch unit, an instruction decode unit, two data paths and a register files for them. The data paths execute the instructions. Each data path includes four functional units L, S, M, D, suffixed 1 or 2 for the respective data path. Control registers and logic, test logic, interrupt logic, and emulation logic are also included. Plural pixel data is packed into each processor data word. In this example, the data processing apparatus operates on 32 bit data words. Luma and chroma pixel data may be expressed in 8 bits and packed into each 32-bit data word. The data processing apparatus includes many instructions that operate in single instruction multiple data (SIMD) mode by separately considering plural parts of the processor data word. For example, and ADD instruction can operate separately on four 8-bit parts of the 32-bit data word by breaking the carry chain between 8-bit sections. Various manipulation instructions and circuits for the packed data are also provided. The IVA subsystem is suitably provided with L1 and L2 caches, RAM and ROM, and hardware accelerators as desired such as for motion estimation, variable length codec, and other processing.

DMA (direct memory access) performs target accesses via target firewalls 3522.i and 3512.i of FIG. 14 connected on interconnects 2640. A target is a circuit block targeted or accessed by another circuit block operating as an initiator. In order to perform such accesses the DMA channels in DMA subsystems 3510.i are programmed. Each DMA channel specifies the source location of the Data to be transferred from an initiator and the destination location of the Data for a target. Some Initiators are MPU 2610, DSP DMA 3510.2, SDMA 3510.1, Universal Serial Bus USB HS, virtual processor data read/write and instruction access, virtual system direct memory access, display 3510.4, DSP MMU (memory management unit), camera 3510.3, and a secure debug access port to emulation block EMU for testing and debug (not to be confused with emulation prevention pattern insertion and removal).

Data exchange between a peripheral subsystem and a memory subsystem and general system transactions from memory to memory are handled by the System SDMA 3510.1. Data exchanges within a DSP subsystem 3510.2 are handled by the DSP DMA 3518.2. Data exchange to store camera capture is handled using a Camera DMA 3518.3 in camera subsystem CAM 3510.3. The CAM subsystem 3510.3 suitably handles one or two camera inputs of either serial or parallel data transfer types, and provides image capture hardware image pipeline and preview. Data exchange to refresh a display is handled in a display subsystem 3510.4 using a DISP (display) DMA 3518.4. This subsystem 3510.4, for instance, includes a dual output three layer display processor for 1xGraphics and 2xVideo, temporal dithering (turning pixels on and off to produce grays or intermediate colors) and SDTV to QCIF video format and translation between other video format pairs. The Display block 3510.4 feeds an LCD (liquid crystal display), plasma display, DLP™ display panel or DLP™ projector system, using either a serial or parallel interface. Also television output TV and Amp provide CVBS or S-Video output and other television output types.

In FIG. 14, a hardware security architecture including SSM 2460 propagates Mreqxxx qualifiers on the interconnect 3521 and 3534. The MPU 2610 issues bus transactions and sets some qualifiers on Interconnect 3521. SSM 2460 also provides one or more MreqSystem qualifiers. The bus transactions propagate through the L4 Interconnect 3534 and line 3538 then reach a DMA Access Properties Firewall 3512.1. Transactions are coupled to a DMA engine 3518.i in each subsystem 3510.i which supplies a subsystem-specific interrupt to the Interrupt Handler 2720. Interrupt Handler 2720 is also fed one or more interrupts from Secure State Machine SSM 2460 that performs security protection functions. Interrupt Handler 2720 outputs interrupts for MPU 2610. In FIG. 14, firewall protection by firewalls 3522.i is provided for various system blocks 3520.i, such as GPMC (General Purpose Memory Controller) to Flash memory 3520.1, ROM 3520.2, on-chip RAM 3520.3, Video Codec 3520.4, WCDMA/HSDPA 3520.6, device-to-device SAD2D 3520.7 to Modem chip 1100, and a DSP 3520.8 and DSP DMA 3528.8. In some system embodiments, Video Codec 3520.4 has codec embodiments as shown in the other Figures herein. A System Memory Interface SMS with SMS Firewall 3555 is coupled to SDRC 3552.1 (External Memory Interface EMIF with SDRAM Refresh Controller) and to system SDRAM 3550 (Synchronous Dynamic Random Access Memory).

In FIG. 14, interconnect 3534 is also coupled to Control Module 2765 and cryptographic accelerators block 3540 and PRCM 3570. Power, Reset and Clock Manager PCRM 3570 is coupled via L4 interconnect 3534 to Power IC circuitry in chip 1200 of FIGS. 1-3, which supplies controllable supply voltages VDD1, VDD2, etc. PRCM 3570 is coupled to L4 Interconnect 3534 and coupled to Control Module 2765. PRCM 3570 is coupled to a DMA Firewall 3512.1 to receive a Security Violation signal, if a security violation occurs, and to respond with a Cold or Warm Reset output. Also PRCM 3570 is coupled to the SSM 2460.

In FIG. 14, some embodiments have symmetric multiprocessing (SMP) core(s) such as RISC processor cores in the MPU subsystem. One of the cores is called the SMP core. A hardware (HW) supported secure hypervisor runs at least on the SMP core. Linux SMP HLOS (high-level operating system) is symmetric across all cores and is chosen as the master HLOS in some embodiments.

The embodiments are suitably employed in gateways, decoders, set top boxes, receivers for receiving satellite video, cable TV over copper lines or fiber, DSL (Digital subscriber line) video encoders and decoders, television broadcasting, optical disks and other storage media, encoders and decoders for video and multimedia services over packet networks, in video teleconferencing, and video surveillance.

The system embodiments of and for FIG. 14 are also provided in a communications system and implemented as various embodiments in any one, some or all of cellular mobile telephone and data handsets, a cellular (telephony and data) base station, a WLAN AP (wireless local area network access point, IEEE 802.11 or otherwise), a Voice over WLAN Gateway with user video/voice over packet telephone, and a video/voice enabled personal computer (PC) with another user video/voice over packet telephone, that communicate with each other. A camera CAM provides video pickup for a cell phone or other device to send over the internet to another cell phone, personal digital assistant/personal entertainment unit, gateway and/or set top box STB with television TV. Video storage and other storage, such as hard drive, flash drive, high density memory, and/or compact disk (CD) is provided for digital video recording (DVR) embodiments such as for delayed reproduction, transcoding, and retransmission of video to other handsets and other destinations. An STB embodiment includes a system interface, front end hardware, a framer, a multiplexer, a multi-stream bidirectional cable card (M-Card), and a demultiplexer. The STB includes a main processor(s), a transport packet parser, and a decoder, improved as taught herein and provided on a printed circuit board (PCB), a printed wiring board (PWB), and/or in an integrated circuit on a semiconductor substrate.

In FIG. 14, a Modem integrated circuit (IC) 1100 supports and provides wireless interfaces for any one or more of GSM, GPRS, EDGE, UMTS, and OFDMA/MIMO embodiments. Codecs for any or all of CDMA (Code Division Multiple Access), CDMA2000, and/or WCDMA (wideband CDMA or UMTS) wireless are provided, suitably with HSDPA/HSUPA (High Speed Downlink Packet Access, High Speed Uplink Packet Access) (or 1xEV-DV, 1xEV-DO or 3xEV-DV) data feature via an analog baseband chip and RF GSM/CDMA chip to a wireless antenna. Replication of blocks and antennas is provided in a cost-efficient manner to support MIMO OFDMA of some embodiments. Modem 1100 also includes an television RF front end and demodulator for HDTV and DVB (Digital Video Broadcasting) to provide H.264 and other packetized compressed video/audio streams for Start Code detection, slice parsing, and entropy decoding by the circuits of the other Figures herein. An audio block in an Analog/Power IC 1200 has audio I/O (input/output) circuits to a speaker, a microphone, and/or headphones as illustrated in FIG. 14. A touch screen interface is coupled to a touch screen XY off-chip in some embodiments for display and control. A battery provides power to mobile embodiments of the system and battery data on suitably provided lines from the battery pack.

DLP™ display technology from Texas Instruments Incorporated is coupled to one or more imaging/video interfaces. A transparent organic semiconductor display is provided on one or more windows of a vehicle and wirelessly or wireline-coupled to the video feed. WLAN and/or WiMax integrated circuit MAC (media access controller), PHY (physical layer) and AFE (analog front end) support streaming video over WLAN. A MIMO UWB (ultra wideband) MAC/PHY supports OFDM in 3-10 GHz UWB bands for communications in some embodiments. A digital video integrated circuit provides television antenna tuning, antenna selection, filtering, RF input stage for recovering video/audio and controls from a DVB station.

Various embodiments are thus used with one or more microprocessors, each microprocessor having a pipeline, and selected from the group consisting of 1) reduced instruction set computing (RISC), 2) digital signal processing (DSP), 3) complex instruction set computing (CISC), 4) superscalar, 5) skewed pipelines, 6) in-order, 7) out-of-order, 8) very long instruction word (VLIW), 9) single instruction multiple data (SIMD), 10) multiple instruction multiple data (MIMD), 11) multiple-core using any one or more of the foregoing, and 12) microcontroller pipelines, control peripherals, and other micro-control blocks using any one or more of the foregoing.

A packet-based communication system can be an electronic (wired or wireless) communication system or an optical communication system.

Various embodiments as described herein are manufactured in a process that prepares RTL (register transfer language or hardware design language HDL) and netlist for a particular design including circuits of the Figures herein in one or more integrated circuits or a system. The design of the encoder and decoder and other hardware is verified in simulation electronically on the RTL and netlist. Verification checks contents and timing of registers, operation of hardware circuits under various configurations, correct Start Code, NAL unit parsing, and data stream detection, bit operations and encode and/or decode for H.264 and other video coded bit streams, proper responses to commands (loosely-coupled) and instructions (tightly-coupled), real-time and non-real-time operations and interrupts, responsiveness to transitions through modes, sleep/wakeup, and various attack scenarios. When satisfactory, the verified design dataset and pattern generation dataset go to fabrication in a wafer fab and packaging/assembly produces a resulting integrated circuit and tests it with real time video. Testing verifies operations directly on first-silicon and production samples such as by using scan chain methodology on registers and other circuitry until satisfactory chips are obtained. A particular design and printed wiring board (PWB) of the system unit, has a video codec applications processor coupled to a modem, together with one or more peripherals coupled to the processor and a user interface coupled to the processor. A storage, such as SDRAM and Flash memory is coupled to the system and has VLC tables, configuration and parameters and a real-time operating system RTOS, image codec-related software such as for processor issuing Commands and Instructions as described elsewhere herein, public HLOS, protected applications (PPAs and PAs), and other supervisory software. System testing tests operations of the integrated circuit(s) and system in actual application for efficiency and satisfactory operation of fixed or mobile video display for continuity of content, phone, e-mails/data service, web browsing, voice over packet, content player for continuity of content, camera/imaging, audio/video synchronization, and other such operation that is apparent to the human user and can be evaluated by system use. Also, various attack scenarios are applied. If further increased efficiency is called for, parameter(s) are reconfigured for further testing. Adjusted parameter(s) are loaded into the Flash memory or otherwise, components are assembled on PWB to produce resulting system units.

Aspects (See Notes Paragraph at End of this Aspects Section.)

12A. The data processing circuit claimed in claim 12 further comprising a data buffer, and wherein said accelerator is responsive to such entropy decode instruction and a zero or one entry for left most bits detection to entropy decode data from said data buffer.

12B. The data processing circuit claimed in claim 12 further comprising a bus, and said accelerator includes a request register accessible over said bus to enter a request for a type of entropy decode, and a plurality of request-specific decoders coupled to said request register to provide the type of decode requested.

14A. The data processing circuit claimed in claim 14 further comprising a left most bits detector coupled to provide an input to a said request-specific decoder for truncated element decode.

14B. The data processing circuit claimed in claim 14 further comprising a leading bits circuit operable to identify a number N of leading bits that are terminated by an opposite-valued bit in an entropy code, a selector responsive to said leading bits counter to select an equal number of data bits that follow that opposite-valued bit, those data bits representing a binary number X, and an arithmetic circuit operable to supply an electronic representation of a sum of X plus 2^{N}−1 to at least two of the plurality of request-specific decoders.

18A. The electronic circuit claimed in claim 18 further comprising an instruction register coupled to said bus, and an instruction decoder responsive to an instruction in said instruction register to selectively activate operation of said control logic.

18A1. The electronic circuit claimed in claim 18A wherein said instruction decoder is responsive to at least one instruction in said instruction register selected from the group consisting of 1) get bits, 2) put bits, 3) show bits.

18B. The electronic circuit claimed in claim 18 further comprising a data processor with a storage circuit, said data processor coupled to said bus and operable to access said input register and to configure said data width request register and activate said control logic.

18C. The electronic circuit claimed in claim 18 wherein the data unit size is one byte, and the data processing operation includes a bit operation on bits in a byte.

18C1. The electronic circuit claimed in claim 18C wherein said control logic circuit thereby effectuates a show bits instruction.

19A. The electronic circuit claimed in claim 19 wherein said control logic circuit thereby effectuates a put bits instruction.

24A. The bit processing circuit claimed in claim 24 further comprising an instruction decoder responsive to an instruction in said instruction register to activate operation of said control logic.

24A1. The bit processing circuit claimed in claim 24A wherein said control circuit is operable repeatedly in response to repeated assertion of the instruction with a request value.

24B. The bit processing circuit claimed in claim 24 wherein said control circuit includes a transfer circuit and a bit-wise OR gate coupled with at least one of said data registers to transfer a specified number of bits and bit-wise-OR the transferred bits with at least one of said data registers and store the result of the bit-wise-OR in at least one of said data registers.

29A. The emulation prevention data processing circuit claimed in claim 29 wherein said bit pattern register circuit is operable to hold specified bit patterns that include a predetermined emulation prevention pattern.

29B. The emulation prevention data processing circuit claimed in claim 29 wherein the emulation prevention pattern has an emulation prevention byte, and said bit stream circuit further includes a buffer register coupled to said stream buffer, said buffer register operable to hold part of the bit stream and wherein the delete circuit is operable to shift a higher byte into a next lower byte in said buffer register to delete the emulation prevention byte.

30A. The emulation prevention data processing circuit claimed in claim 30 wherein said bit pattern register circuit is also operable to hold specified bit patterns that lack a predetermined emulation prevention pattern and when present in the bit stream are at risk of confusion with a specified start code on ultimate decode unless said pattern insertion circuit is operated.

Notes about Aspects above: Aspects are paragraphs which might be offered as claims in patent prosecution. The above dependently-written Aspects have leading digits and internal dependency designations to indicate the claims or aspects to which they pertain. Aspects having no internal dependency designations have leading digits and alphanumerics to indicate the position in the ordering of claims at which they might be situated if offered as claims in prosecution.

Processing circuitry comprehends digital, analog and mixed signal (digital/analog) integrated circuits, ASIC circuits, PALs, PLAs, decoders, memories, and programmable and nonprogrammable processors, microcontrollers and other circuitry. Internal and external couplings and connections can be ohmic, capacitive, inductive, photonic, and direct or indirect via intervening circuits or otherwise as desirable. Process diagrams herein are representative of flow diagrams for operations of any embodiments whether of hardware, software, or firmware, and processes of manufacture thereof. Flow diagrams and block diagrams are each interpretable as representing structure and/or process. While this invention has been described with reference to illustrative embodiments, this description is not to be construed in a limiting sense. Various modifications and combinations of the illustrative embodiments, as well as other embodiments of the invention may be made. The terms including, includes, having, has, with, or variants thereof are used in the detailed description and/or the claims to denote non-exhaustive inclusion in a manner similar to the term comprising. The appended claims and their equivalents cover any such embodiments, modifications, and embodiments as fall within the scope of the invention.

What is claimed is:

1. A video decoder comprising:
a memory operable to hold entropy coded video data accessible as a bit stream;
a processor operable to issue at least one command for loose-coupled support and to issue at least one instruction for tightly-coupled support;
a bit stream unit coupled to said memory and to said processor and responsive to at least one command to provide the loose-coupled support and command-related accelerated processing of the bit stream; and
a second bit stream unit coupled to said memory and to said processor and responsive to said at least one instruction to provide the tightly-coupled support and instruction-related accelerated processing of the bit stream.

2. The video decoder claimed in claim 1 wherein said processor is operable to issue an instruction selected from the group consisting of 1) get bits, 2) put bits, 3) show bits, 4) entropy decode, 5) byte align bit pointer.

3. The video decoder claimed in claim 1 wherein said processor is operable to issue entropy decode-specific instructions selected from the group consisting of 1) signed element decode, 2) unsigned element decode, 3) truncated element decode, 4) mapping.

4. The video decoder claimed in claim 1 for use with a bit stream including instances of an interspersed start code wherein said at least one command includes a command to detect a next start code.

5. The video decoder claimed in claim 1 wherein said second bit stream unit includes a first stage stream decoder, and a second stage stream decoder, and a stream data unit shared by both said first stage stream decoder and said second stage stream decoder.

6. The video decoder claimed in claim 5 wherein said bit stream unit further includes a bus and separately-accessible registers respectively coupled to said bus to enter such a command and to enter such an instruction.

7. The video decoder claimed in claim 5 wherein said bit stream unit further includes a decode circuit responsive to such an instruction to operate said first stage stream decoder and responsive to such another such instruction to operate said second stage stream decoder.

8. The video decoder claimed in claim 1 wherein said second bit stream unit includes a leading bits circuit operable to identify how many leading bits are terminated by an opposite-valued bit in an entropy code, and a code number circuit responsive to said leading bits counter to select an equal number of data bits that follow that opposite-valued bit and to generate an electronic representation of a number in response to the leading bits and those data bits jointly, thereby to evaluate the entropy code.

9. A bit stream decoder comprising:
a processor operable to issue at least one command for loose-coupled support, and to issue at least one instruction for tightly-coupled support, and having processor delay slots; and
bit stream hardware responsive to such command and operable as a substantially autonomous unit independent of the processor delay slots to provide accelerated processing of the bit stream.

10. The bit stream decoder claimed in claim 9 for use with a bit stream including instances of an interspersed start code wherein said at least one command includes a command to detect a next start code.

11. The bit stream decoder claimed in claim 9 further comprising a start code detector circuit responsive to such command, and a register fed by said start code detector circuit and having output fields for start code detection and packet size of a packet prefixed by the start code.

12. A data processing circuit comprising:
a processor operable to issue at least one command for loose-coupled support, and to issue at least one instruction for support during processor delay slots; and
an accelerator responsive to execute at least one bit stream processing instruction to provide accelerated processing of the bit stream during processor delay slots, such instruction selected from the group consisting of 1) get bits, 2) put bits, 3) show bits, 4) entropy decode, 5) byte align bit pointer.

13. The data processing circuit claimed in claim 12 further comprising a bus, and said accelerator includes an instruction register accessible over said bus to enter such an instruction, a data buffer, and a decode circuit responsive to such instruction in said instruction register to insert a bit pattern into data in the data buffer.

14. The data processing circuit claimed in claim 12 wherein said processor is further operable to issue entropy decode-specific requests, and said accelerator is responsive to execute such a request selected from the group consisting of 1) signed element decode, 2) unsigned element decode, 3) truncated element decode, 4) mapping.

15. The data processing circuit claimed in claim 14 further comprising a bit stream-responsive code number generator circuit coupled to provide an input to each of the plurality of request-specific decoders.

16. The data processing circuit claimed in claim 14 further comprising a chroma format IDC circuit and a look up table each coupled to provide an input to a said request-specific decoder for mapping, and an output register fed by said mapping decoder with CBP intra and CBP inter fields.

17. The data processing circuit claimed in claim 12 wherein said accelerator includes a leading bits circuit operable to identify how many leading bits are terminated by an opposite-valued bit in an entropy code, a selector responsive to said leading bits counter to select an equal number of data bits that follow that opposite-valued bit, those data bits representing a binary number X, and an arithmetic circuit operable to generate an electronic representation of a number Y as a function of X and said how many leading bits, thereby to evaluate an entropy code.

18. An electronic circuit comprising:
a bus;
an input register coupled for entry of data from said bus;
a data working buffer coupled to said input register;
an output register coupled to said bus for read access thereof;
a transfer circuit selectively operable to transfer data from said data working buffer to said output register;
a data width request register coupled to said bus; and
a control logic circuit conditionally operable in response to said data width request register to detect a first condition responsive at least to said data width request register when a data unit size in said data working buffer would be exceeded to activate repeated control of said transfer circuit for plural transfer operations, and otherwise operable on a second condition representing that the data unit size is not exceeded to execute a data processing operation involving said data working buffer, and after detection of either of said conditions further operable to issue a subsequent control for a further transfer circuit operation.

19. The electronic circuit claimed in claim 18 wherein said control logic is operable to insert bits from said input register into a data stream mediated by said data working buffer and actuate said transfer circuit to transfer said data stream from said data working buffer to said output register.

20. The electronic circuit claimed in claim 18 further comprising a bit pointer register and wherein said control logic circuit first condition also is jointly responsive to said bit pointer register and said data width request register to detect when the data unit size of said data working buffer would be exceeded and to activate the repeated control.

21. The electronic circuit claimed in claim 18 further comprising a pointer register wherein said control logic is operable to detect a third condition representing a pointer register condition to disqualify the subsequent control, whereby the further transfer circuit operation is selectively obviated.

22. The electronic circuit claimed in claim 18 further comprising an instruction register and a pointer register and said control logic includes a pointer update circuit coupled to said pointer register and conditionally activated depending on which instruction is in said instruction register.

23. The electronic circuit claimed in claim 18 further comprising a loop count register, and said control logic is operable to terminate the repeated control after completion of a number of repeated control operations related to a value in said loop count register.

24. A bit processing circuit comprising:
an instruction register operable to hold a request value electronically representing a number of bits to extract from data;
a first data register having a width;
a second data register having a second width and coupled to said first data register;
a source of data coupled to at least said second data register;
an output register;
a remaining bits register operable to hold a remaining-number value electronically representing a number for data bits remaining in said second data register; and
a control circuit responsive to said instruction register to copy bits from said first data register to said output register equal in number to the request value, transfer the rest of the bits in said first data register toward one end of said first data register regardless of the copied bits, transfer bits from said second data register to said first data register equal in number to the request value, and decrement the remaining-number value by the request value.

25. The bit processing circuit claimed in claim 24 further comprising an available-number register, wherein said control circuit is further operable, in case the remaining-number value is less than the request value number of bits, to enter a magnitude of their difference into the available number register and fill the second data register from said source of data and transfer a number of bits equal to the available number value from the second data register to the first data register and enter a remaining number value equal to the second width less the available number value.

26. The bit processing circuit claimed in claim 24 wherein said control circuit is operable beforehand to provide the first and second data registers with bits from said source of data and initialize said remaining bits register to a value representing the number of bits provided to said second data register from said source of data.

27. The bit processing circuit claimed in claim 24 wherein said control circuit is further operable to transfer the rest of the bits in said second data register toward one end of said second data register regardless of the previously transferred bits therefrom.

28. An emulation prevention data processing circuit comprising:
a bit stream circuit for a bit stream to which emulation prevention applies;
a bit pattern register circuit for holding a plurality of bit patterns;
a plurality of comparators coupled to said register circuit and operable to respectively compare each of the bit patterns held in said register circuit with the bit stream, said comparators having match outputs; and
an output register having a flag field which is coupled for activation if any of the match outputs from said comparators becomes active.

29. The emulation prevention data processing circuit claimed in claim 28 wherein said bit stream circuit includes a stream buffer, the bit stream having variable length codes including an emulation prevention pattern, and a circuit operable to delete the emulation prevention pattern from said bit stream when any of the match outputs from said comparators becomes active.

30. The emulation prevention data processing circuit claimed in claim 28 further comprising an emulation prevention pattern register, a variable length encoder for supplying the bit stream, and a pattern insertion circuit operable to insert an emulation prevention pattern from said emulation prevention pattern register into said bit stream when any of the match outputs from said comparators becomes active.

31. The emulation prevention data processing circuit claimed in claim 28 further comprising an emulation prevention pattern register, a configuration register for establishing modes including a bit pattern insertion mode or a bit pattern deletion mode, and a pattern control circuit responsive to said configuration register and operable in the bit pattern insertion mode to insert an emulation prevention pattern from said emulation prevention pattern register into said bit stream when any of the match outputs from said comparators becomes active, and operable in the bit pattern deletion mode to delete the emulation prevention pattern from said bit stream when any of the match outputs from said comparators becomes active.

32. The emulation prevention data processing circuit claimed in claim 28 further comprising a running counter incremented by any of said comparators detecting a match.

33. An electronic bit insertion circuit comprising:
a working buffer circuit of limited size operable to store bits and to specify a bit pointer position;
an insertion register circuit operable to store insertion bits and a width value pertaining to the insertion bits;
an output register circuit; and
a control circuit operable to initially transfer at least some of the insertion bits to said working buffer circuit and transfer all the bits in said working buffer circuit to said output circuit and conditionally operable, when a sum of the bit pointer position and the width value exceeds the limited size, to transfer the remaining bits among the insertion bits to said working buffer circuit and additionally transfer the remaining insertion bits to said output circuit.

34. The electronic bit insertion circuit claimed in claim 33 wherein the conditional operability of said control circuit also includes updating the bit pointer position to that sum, modulo the limited size.

35. The electronic bit insertion circuit claimed in claim 33 wherein the conditional operability of said control circuit also includes transferring the remaining insertion bits from a less-significant bits (LSB) area of said insertion register circuit to a more-significant bits (MSB) area of said working buffer circuit, and transferring the bits from said working buffer circuit to said output circuit to accomplish the additional transfer.

36. The electronic bit insertion circuit claimed in claim 33 wherein the initial transfer of at least some of the insertion bits puts them contiguous to the bit pointer position in the working buffer circuit.

37. An electronic bits transfer circuit comprising:
a data working buffer operable to receive a data stream segment including one or more bytes;
an output register circuit; and
a control circuit including a shift circuit and operable to assemble a contiguous set of bits spanning one or more of the bytes by oppositely-directed shifts of bits involving at least one of said data working buffer and said output register, so that bits extraneous to requested bits are eliminated.

38. The electronic bits transfer circuit claimed in claim 37 wherein the control circuit is operable for at least two shifts in one direction prior to the further shift in the opposite direction.
